(19) United States
(12) Patent Application Publication
(10) Pub. No.: US 2026/0046660 A1
(43) Pub. Date: Feb. 12, 2026

(54) BEAM MANAGEMENT PROCEDURES USING PREDICTED BEAM MEASUREMENTS

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/101,861

(22) PCT Filed: Sep. 15, 2022
(86) PCT No.: PCT/CN2022/118938

§ 371 Date: Feb. 6, 2025

(51) Int. Cl. H04W 24/10; H04B 7/06; H04L 5/00

(52) U.S. Cl. CPC H04W 24/10; H04B 7/06968; H04L 5/0051

(57) ABSTRACT

Various aspects of the present disclosure generally relate to wireless communication. In some aspects, a user equipment (UE) may receive, from a network node, an indication to transmit a channel state information (CSI) report associated with a first set of resources and a second set of resources, and wherein a mapping indicates that each resource included in the second set of resources is associated with at least one resource included in the first set of resources. The UE may transmit, to the network node, the CSI report indicating: one or more measurement values from a set of measurement values associated with the first set of resources, and one or more predicted measurement values associated with a second one or more resources from the second set of resources, that are selected based on the first one or more resources and the mapping. Numerous other aspects are described.

### FIELD OF THE DISCLOSURE

Aspects of the present disclosure generally relate to wireless communication and to techniques and apparatuses for beam management procedures using predicted beam measurements.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example architecture of a functional framework for radio access network (RAN) intelligence enabled by data collection, in accordance with the present disclosure.

FIG. 6 is a diagram illustrating an example of an artificial intelligence/machine learning (AI/ML) based beam management, in accordance with the present disclosure.

FIGS. 7A-7C are diagrams illustrating an example associated with beam management procedures using predicted beam measurements, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### SUMMARY

Some aspects described herein relate to a user equipment (UE) for wireless communication. The UE may include a memory and one or more processors coupled to the memory. The one or more processors may be configured to receive, from a network node, an indication to transmit a channel state information (CSI) report, wherein the CSI report is associated with a first set of resources and a second set of resources, and wherein a mapping indicates that each resource included in the second set of resources is associated with at least one resource included in the first set of resources. The one or more processors may be configured to measure one or more signals associated with resources included in the first set of resources to obtain a set of measurement values. The one or more processors may be configured to transmit, to the network node, the CSI report indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Some aspects described herein relate to a network node for wireless communication. The network node may include a memory and one or more processors coupled to the memory. The one or more processors may be configured to transmit an indication that a UE is to transmit a CSI report, wherein the CSI report is associated with a first set of resources and a second set of resources, and wherein a mapping indicates that each resource included in the second set of resources is associated with at least one resource included in the first set of resources. The one or more processors may be configured to receive the CSI report, associated with the UE, indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Some aspects described herein relate to a method of wireless communication performed by an apparatus of a UE. The method may include receiving, from a network node, an indication to transmit a CSI report, wherein the CSI report is associated with a first set of resources and a second set of resources, and wherein a mapping indicates that each resource included in the second set of resources is associated with at least one resource included in the first set of resources. The method may include measuring one or more signals associated with resources included in the first set of resources to obtain a set of measurement values. The method may include transmitting, to the network node, the CSI report indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Some aspects described herein relate to a method of wireless communication performed by an apparatus of a network node. The method may include transmitting an indication that a UE is to transmit a CSI report, wherein the CSI report is associated with a first set of resources and a second set of resources, and wherein a mapping indicates that each resource included in the second set of resources is associated with at least one resource included in the first set of resources. The method may include receiving the CSI report, associated with the UE, indicating: one or more measurement values from a set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Some aspects described herein relate to a non-transitory computer-readable medium that stores a set of instructions for wireless communication by a one or more instructions that, when executed by one or more processors of a UE. The set of instructions, when executed by one or more processors of the UE, may cause the UE to receive, from a network node, an indication to transmit a CSI report, wherein the CSI report is associated with a first set of resources and a second set of resources, and wherein a mapping indicates that each resource included in the second set of resources is associated with at least one resource included in the first set of resources. The set of instructions, when executed by one or more processors of UE, may cause the UE to measure one or more signals associated with resources included in the first set of resources to obtain a set of measurement values. The set of instructions, when executed by one or more processors of the UE, may cause the UE to transmit, to the network node, the CSI report indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Some aspects described herein relate to a non-transitory computer-readable medium that stores a set of instructions for wireless communication by a network node. The set of instructions, when executed by one or more processors of the network node, may cause the network node to transmit an indication that a UE is to transmit a CSI report, wherein the CSI report is associated with a first set of resources and a second set of resources, and wherein a mapping indicates that each resource included in the second set of resources is associated with at least one resource included in the first set of resources. The set of instructions, when executed by one or more processors of the network node, may cause the network node to receive the CSI report, associated with the UE, indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Some aspects described herein relate to an apparatus for wireless communication. The apparatus may include means for receiving, from a network node, an indication to transmit a CSI report, wherein the CSI report is associated with a first set of resources and a second set of resources, and wherein a mapping indicates that each resource included in the second set of resources is associated with at least one resource included in the first set of resources. The apparatus may include means for measuring one or more signals associated with resources included in the first set of resources to obtain a set of measurement values. The apparatus may include means for transmitting, to the network node, the CSI report indicating, one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Some aspects described herein relate to an apparatus for wireless communication. The apparatus may include means for transmitting an indication that a UE is to transmit a CSI report, wherein the CSI report is associated with a first set of resources and a second set of resources, and wherein a mapping indicates that each resource included in the second set of resources is associated with at least one resource included in the first set of resources. The apparatus may include means for receiving the CSI report, associated with the UE, indicating, one or more measurement values from a set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

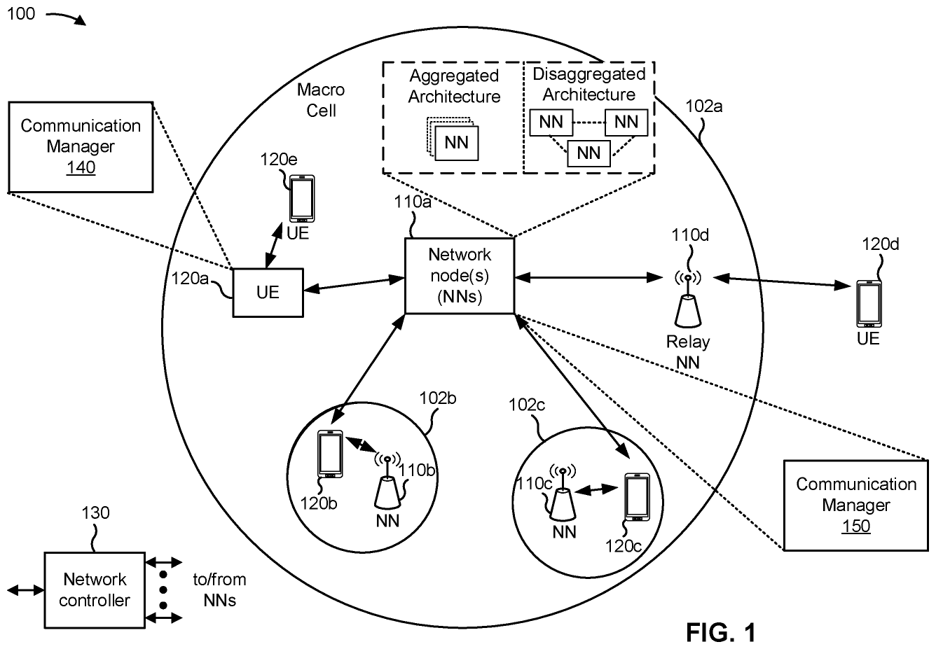

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, an indication to transmit a channel state information (CSI) report, wherein the CSI report is associated with a first set of resources and a second set of resources, and wherein a mapping indicates that each resource included in the second set of resources is associated with at least one resource included in the first set of resources; measure one or more signals associated with resources included in the first set of resources to obtain a set of measurement values; and transmit, to the network node, the CSI report indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources. Additionally, or alternatively, the communication manager 140 may perform one or more other operations described herein.

In some aspects, the network node 110 may include a communication manager 150. As described in more detail elsewhere herein, the communication manager 150 may transmit an indication that a UE is to transmit a CSI report, wherein the CSI report is associated with a first set of resources and a second set of resources, and wherein a mapping indicates that each resource included in the second set of resources is associated with at least one resource included in the first set of resources; and receive the CSI report, associated with the UE, indicating: one or more measurement values from a set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources. Additionally, or alternatively, the communication manager 150 may perform one or more other operations described herein.

As indicated above, FIG. 1 is provided as an example. Other examples may differ from what is described with regard to FIG. 1.

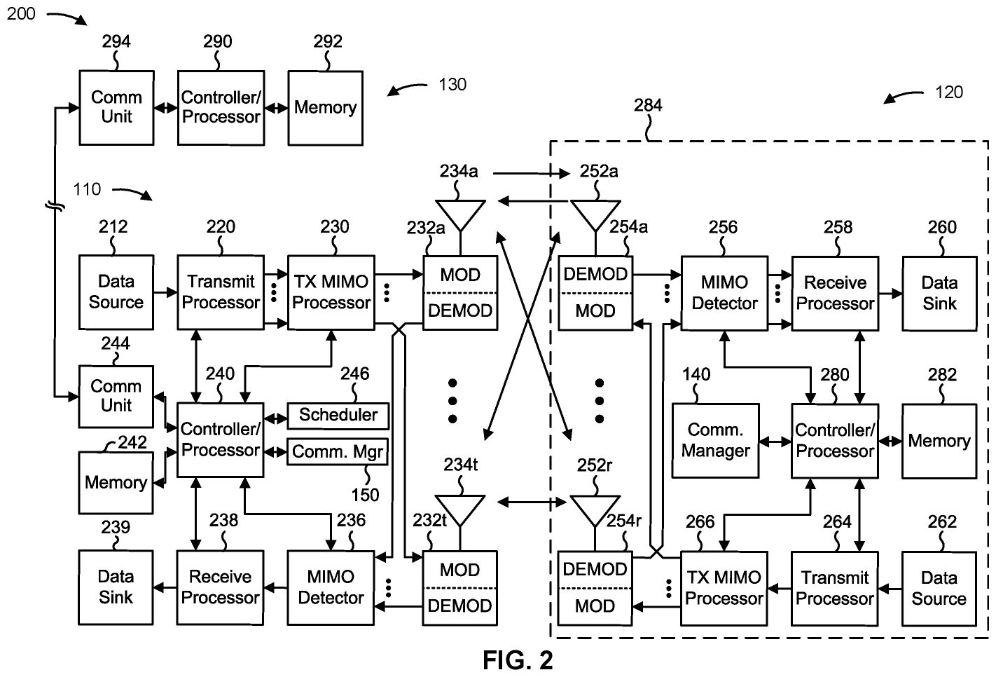

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

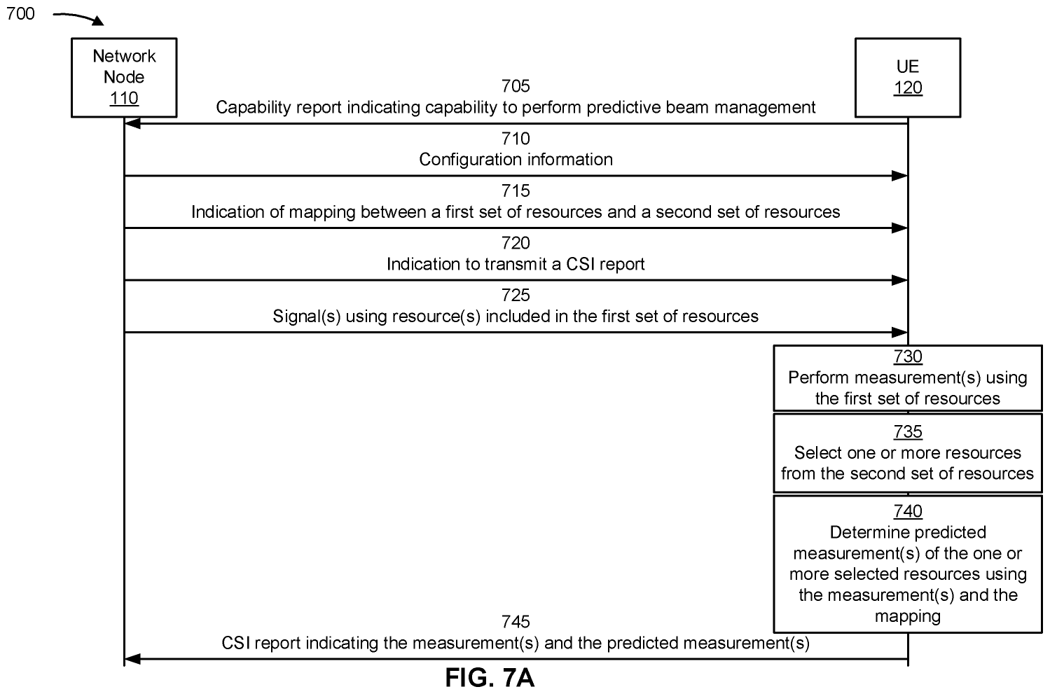

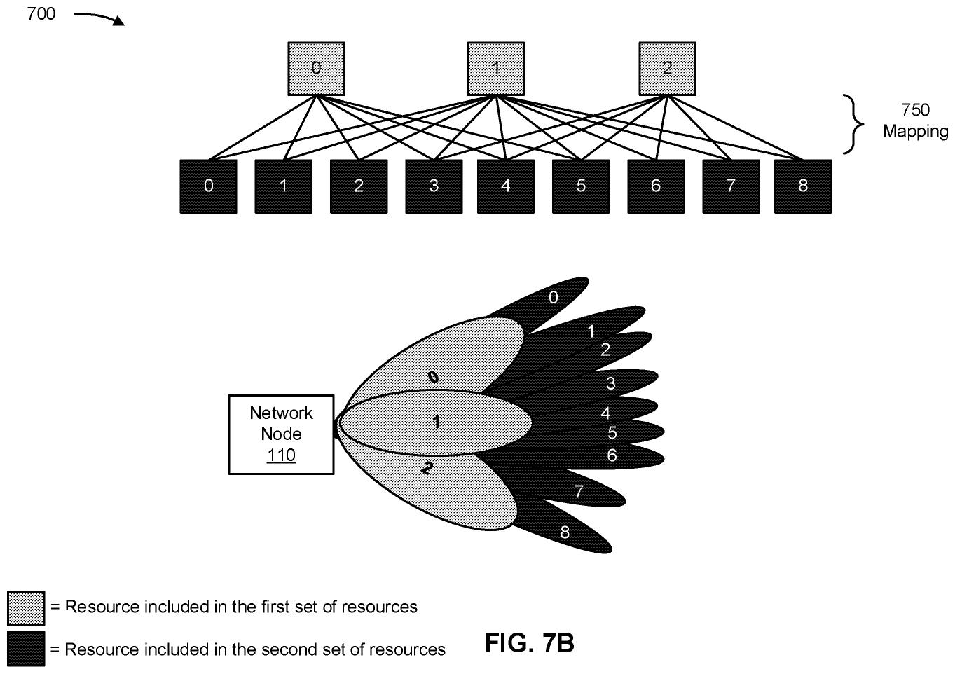

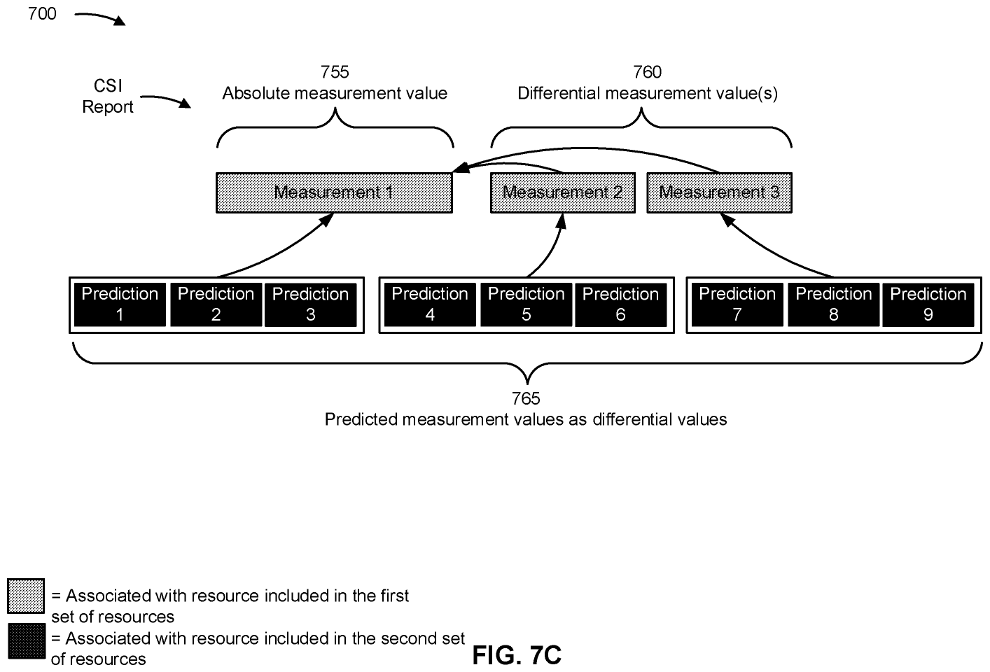

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-7C and 8-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-7C and 8-11).

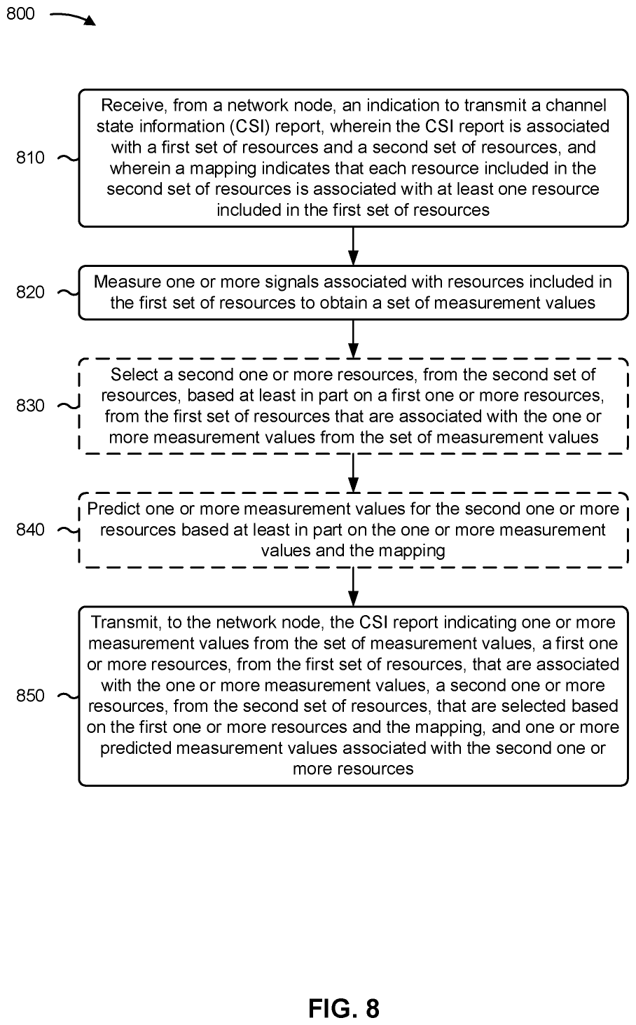

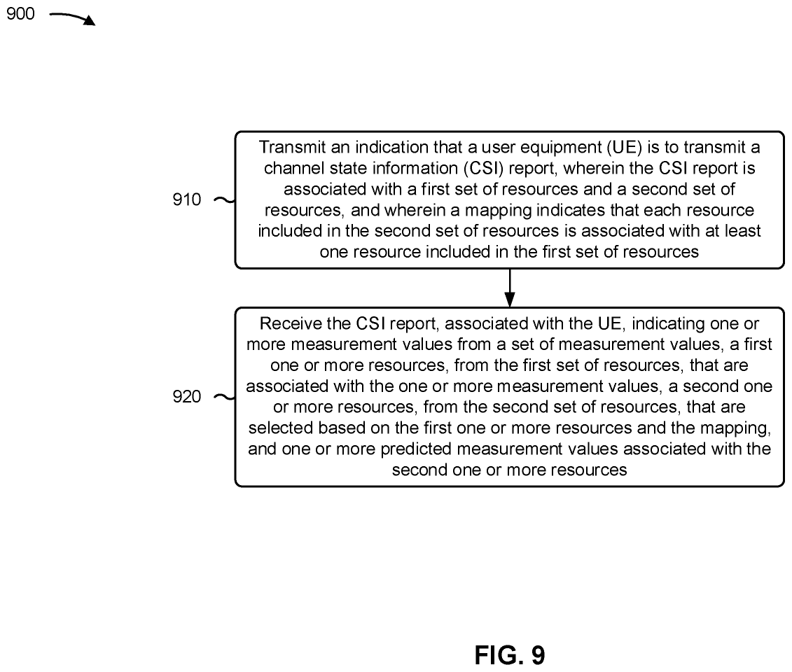

The controller/processor 240 of the network node 110, the controller/processor 280 of the UE 120, and/or any other component(s) of FIG. 2 may perform one or more techniques associated with beam management procedures using predicted beam measurements, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, from a network node, an indication to transmit a CSI report, wherein the CSI report is associated with a first set of resources and a second set of resources, and wherein a mapping indicates that each resource included in the second set of resources is associated with at least one resource included in the first set of resources; means for measuring one or more signals associated with resources included in the first set of resources to obtain a set of measurement values; and/or means for transmitting, to the network node, the CSI report indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication that a UE is to transmit a CSI report, wherein the CSI report is associated with a first set of resources and a second set of resources, and wherein a mapping indicates that each resource included in the second set of resources is associated with at least one resource included in the first set of resources; and/or means for receiving the CSI report, associated with the UE, indicating: one or more measurement values from a set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

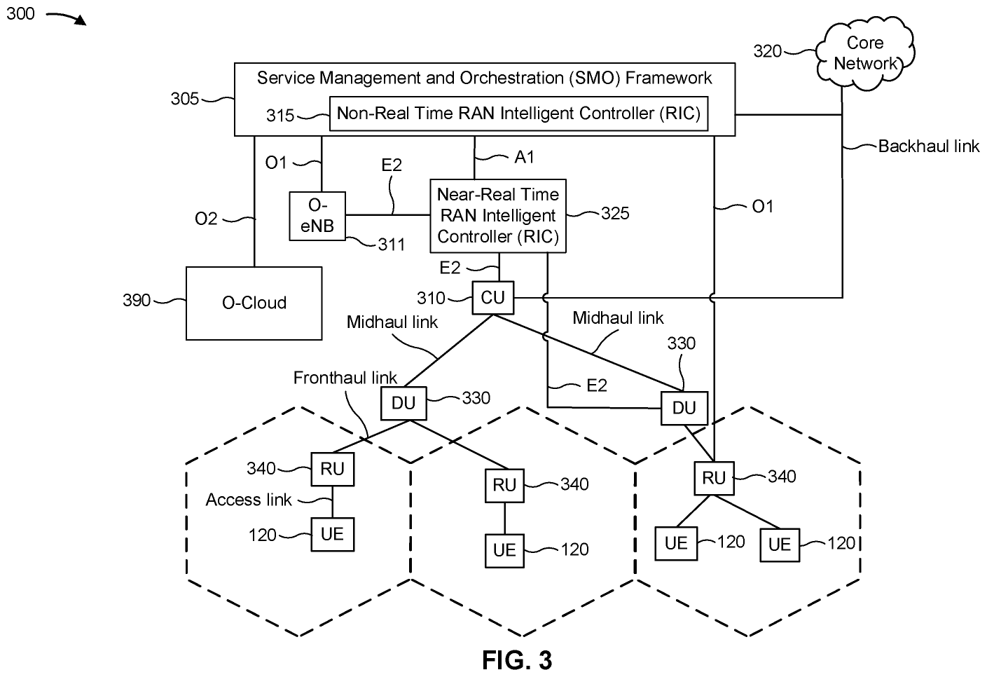

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

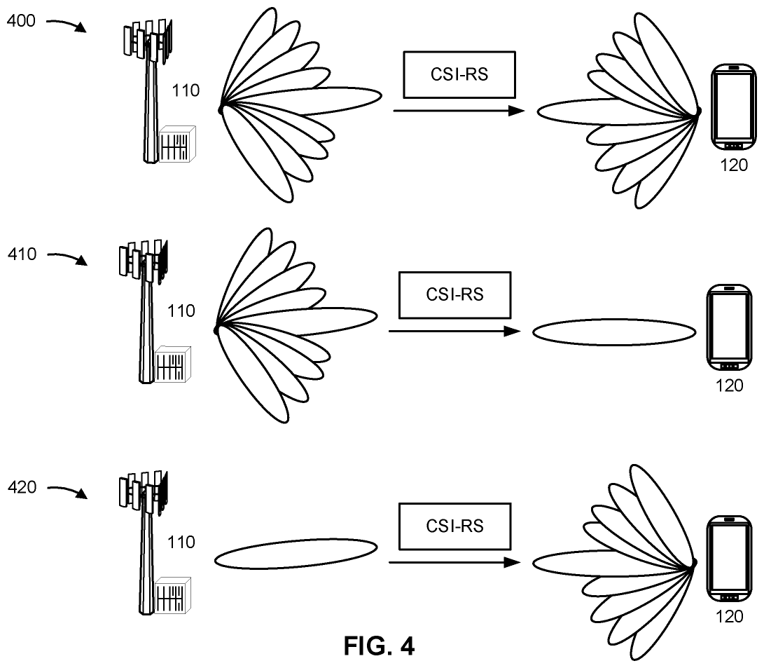

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHZ, FR4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal towards a given direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spread (e.g., few nanoseconds) and may be translated into coherence frequency bandwidth of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on a LOS path at a higher frequency band and the LOS path is blocked by an obstacle, such as pedestrians, buildings, and/or vehicles, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (e.g., such as the beam management procedures described in connection with FIG. 4) may be performed by the UE 120 and/or the network node 110. However, because higher frequency bands may be more susceptible to environmental changes compared to lower frequency bands, the beam management procedures may be performed more frequently and/or using additional beams. This may introduce significant overhead and consume network resources, processing resources, and/or power resources of a UE (and/or a network node) associated with performing the beam management procedures.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

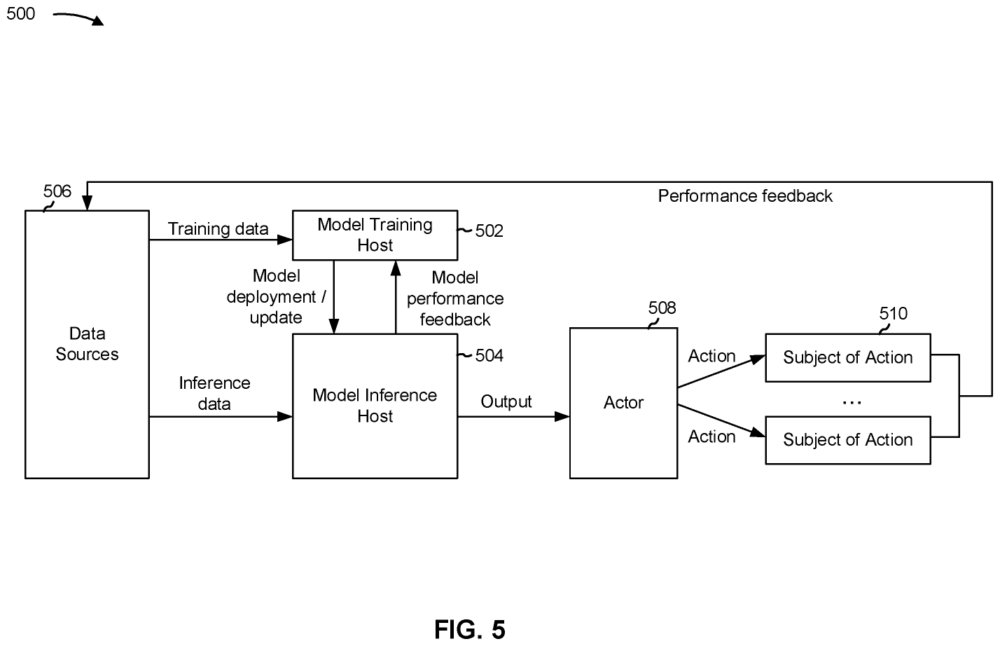

FIG. 5 is a diagram illustrating an example architecture 500 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE, a DU or an RU; whereas if the output from the model inference host 504 is associated with Tx/Rx scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change/modify a Tx/Rx beam based on the output. If the actor 508 determines to act based on the output, the actor 508 may indicate the action to at least one subject of action 510. For example, if the actor 508 determines to change/modify a Tx/Rx beam for a communication between the actor 508 and the subject of action 510 (e.g., a UE 120), then the actor 508 may transmit a beam (re-)configuration or a beam switching indication to the subject of action 510. The actor 508 may modify its Tx/Rx beam based on the beam (re-)configuration, such as switching to a new Tx/Rx beam or applying different parameters for a Tx/Rx beam, among other examples. As another example, the actor 508 may be a UE and the output from the model inference host 504 may be associated with beam management. For example, the output may be one or more predicted measurement values for one or more beams. The actor 508 (e.g., a UE) may determine that a measurement report (e.g., a Layer 1 (L1) RSRP report) is to be transmitted to a network node 110.

The data sources 506 may also be configured for collecting data that is used as training data for training an ML model or as inference data for feeding an ML model inference operation. For example, the data sources 506 may collect data from one or more core network and/or RAN entities, which may include the subject of action 510, and provide the collected data to the model training host 502 for ML model training. For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

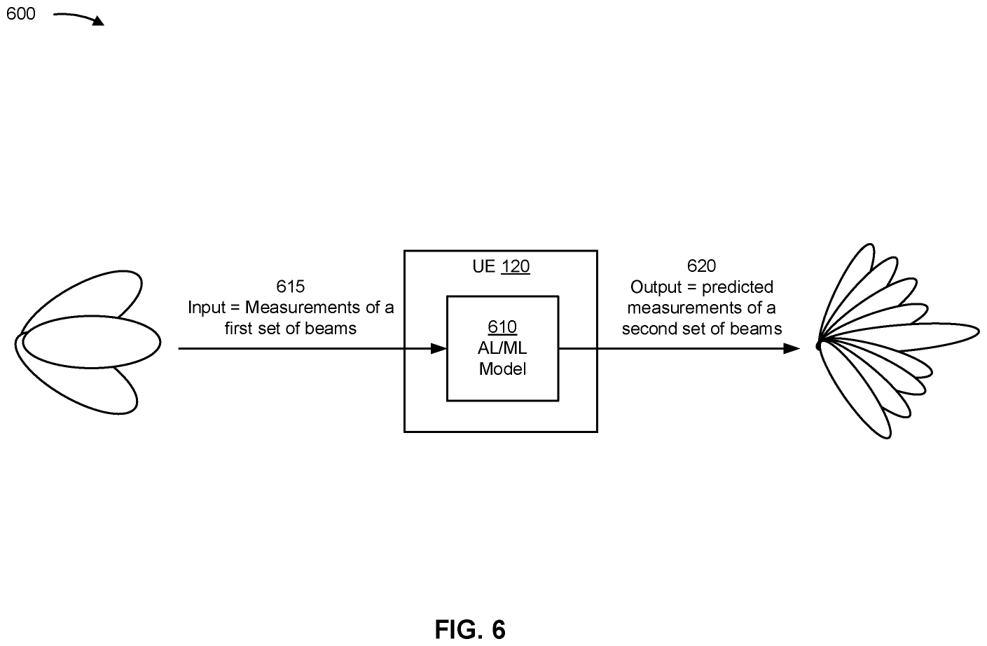

FIG. 6 is a diagram illustrating an example 600 of a AI/ML based beam management, in accordance with the present disclosure. As shown in FIG. 6, an AI/ML model 610 may be deployed at or on a UE 120. For example, a model inference host (such as a model inference host 504) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurements associated with a first set of beams. For example, a network node 110 may transmit one or more signals using respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 610 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 620, the AI/ML model 610 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 610. This may enable the AI/ML model 610 to output codebook based and/or non-codebook based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure as described above in connection with FIG. 4), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

As described above, beam management procedures, such as beam refinement procedures (e.g., a P2 beam management procedure or a P3 beam management procedure as described above in connection with FIG. 4) may be associated with transmitting (e.g., beam sweeping) across a set of refined or narrow beams (e.g., refined or narrow beams as compared to beams used as part of a P1 beam management procedure as described above in connection with FIG. 4). However, because higher frequency bands may be more susceptible to environmental changes compared to lower frequency bands, the beam management procedures may be performed more frequently and/or using additional beams. This may introduce significant overhead and consume network resources, processing resources, and/or power resources of a UE 120 (and/or a network node) associated with performing the beam refinement procedures. In some examples, beam measurement predictions may be used to reduce the overhead and/or conserve network resources, processing resources, and/or power resources of a UE (and/or a network node) associated with performing the beam refinement procedures.

However, to perform the predictions described herein, the UE 120 and/or the AI/ML model 610 may use information associated with the first set of beams and/or the second set of beams in order to accurately perform the predictions. For example, the UE 120 and/or the AI/ML model 610 may use information such as a beam direction (e.g., spatial direction), beam width, beam shape, and/or other characteristics of the respective beams from the first set of beams and/or the second set of beams to accurately perform the predictions described above. However, this information may be associated with beamforming techniques performed at a network node 110. In other words, the UE 120 may not have access to information associated with refined and/or narrow beams that would otherwise be used to perform the beam refinement procedures. As a result, AI/ML predictions performed by the UE 120 may be degraded because the UE 120 may not have access to information of beam characteristics or shapes of beams associated with the AI/ML predictions.

Some techniques and apparatuses described herein enable beam management procedures using predicted beam measurements. For example, some techniques and apparatuses described herein enable a virtual beam refinement procedure (e.g., by obtaining predicted measurement values for measurements associated with a beam refinement procedure) based at least in part on one or more measurements of other beams (e.g., wide beams). For example, the UE 120 may receive an indication to transmit a CSI report. The CSI report may be associated with a first set of resources and a second set of resources. A mapping may indicate that each resource included in the second set of resources is associated with at least one resource included in the first set of resources. The UE 120 may measure one or more signals associated with resources included in the first set of resources to obtain a set of measurement values. The UE 120 may transmit the CSI report, where the CSI report indicates one or more measurement values (e.g., highest measurement values) from the set of measurement values and an indication of resources, from the first set of resources, that are associated with the one or more measurement values. Additionally, the CSI report may indicate one or more predicted measurement values of one or more resources, from the second set of resources, that are selected based on the first one or more resources and the mapping.

For example, the UE 120 may measure a first set of beams (e.g., may measure the first set of resources). Based on the measurement value(s) of the first set of beams, the UE 120 may select (e.g., based on the mapping) one or more resources, from the second set of resources, for which the UE 120 is to predict measurement values (e.g., using an AI/ML model). In other words, the UE 120 may report qualities (e.g., measurement values) of the predicted beams within configured Set A beams that are connected with the strongest beams within configured Set B beams.

For example, the UE 120 and a network node 110 may perform a beam management procedure (e.g., a P1 beam management procedure as described in connection with FIG. 4). The UE 120 may identify refined beams based at least in part on measurements performed as part of the beam management procedure. The UE 120 may predict measurement values for the identified refined beams to obtain predicted measurements values. The predicted measurement values may be similar to what would have otherwise been measured by the UE 120 as part of a beam refinement procedure (e.g., a P2 and/or a P3 beam management procedure as described in connection with FIG. 4). Therefore, the UE 120 may virtually perform the beam refinement procedure(s) by predicting one or more beam measurement values and/or Rx beam, as described in more detail elsewhere herein.

As a result, the UE 120 and/or a network node 110 may conserve a signaling overhead, network resources, processing resources, and/or power resources that would have otherwise been used associated with performing one or more beam refinement procedures. For example, predicted beam measurements for a beam refinement procedure may be obtained via one or more measurements (e.g., of Set B beams) and a configured mapping between a first set of resources (e.g., associated with Set B beams) and a second set of resources (e.g., associated with Set A beams). As a result, the UE 120 may be enabled to perform improved predictive beam management by obtaining beam characteristics (e.g., beam shape and/or beam width) associated with the first set of resources and the second set of resources. Moreover, the UE 120 may be enabled to identify Tx beams of a network node 110 and/or Rx beams of the UE 120 that are to be associated with predicted beam measurements (e.g., based on measurements of the first set of resources), thereby conserving network resources, processing resources, and/or power resources that would have otherwise been used to predict and/or indicate measurement predictions for all resources included in the second set of resources.

As indicated above, FIG. 6 is provided as an example. Other examples may differ from what is described with regard to FIG. 6.

FIGS. 7A-7C are diagrams illustrating an example 700 associated with beam management procedures using predicted beam measurements, in accordance with the present disclosure. As shown in FIG. 7A, a network node 110 (e.g., a base station, a CU, a DU, and/or an RU) may communicate with a UE 120. In some aspects, the network node 110 and the UE 120 may be part of a wireless network (e.g., the wireless network 100). The UE 120 and the network node 110 may have established a wireless connection prior to operations shown in FIG. 7A.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 7A, as shown by reference number 705, the UE 120 may transmit, and the network node 110 may receive, a capability report. The capability report may indicate that the UE 120 supports performing predictive beam management, as described herein. For example, the capability report may indicate that the UE 120 supports performing one or more operations as described in connection with FIGS. 5 and 6. In some aspects, the capability report may indicate that the UE 120 supports identifying beam information for performing predictive beam management using connections between two sets of resources, as described in more detail elsewhere herein. In some aspects, the capability report may indicate that the UE 120 supports performing beam refinement procedures using predicted beam measurements, as described in more detail elsewhere herein. In some aspects, the capability report may indicate one or more supported quantization levels for reporting both beam measurement values and predicted measurement values (e.g., in a CSI report). In some aspects, the UE 120 may be configured to perform one or more operations described herein based at least in part on the capability report indicating that the UE 120 supports performing predictive beam management.

As shown by reference number 710, the network node 110 may transmit, and the UE 120 may receive, configuration information. In some aspects, the UE 120 may receive the configuration information via one or more of system information signaling, RRC signaling, one or more MAC-CEs, and/or DCI, among other examples. In some aspects, the configuration information may include an indication of one or more configuration parameters (e.g., already stored by the UE 120 and/or previously indicated by the network node 110 or other network device) for selection by the UE 120, and/or explicit configuration information for the UE 120 to use to configure itself, among other examples.

In some aspects, the configuration information may indicate that the UE 120 is to perform predictive beam management. For example, the configuration information may indicate that the UE 120 is to use an AI/ML model and/or a model inference host deployed at, or associated with, the UE 120 to predict measurement values (e.g., L1 RSRP values and/or L1 signal-to-interference-plus-noise ratio (SINR) values) associated with one or more beams. For example, the configuration information may indicate that the UE 120 is to predict measurement values associated with transmit beam(s) of the network node 110 (e.g., of an RU) using measurement value(s) (e.g., performed by the UE 120) of other transmit beam(s) of the network node 110.

In some aspects, the configuration information may indicate a first set of resources and a second set of resources. In some aspects, the first set of resources may include downlink reference signal resources, such as SSB resources or CSI-RS resources, among other examples. In some aspects, the first set of resources may be channel measurement resources (CMRs) for CSI reporting (e.g., may be indicated via a resourcesForChannelMeasurement information element). In some aspects, the second set of resources may include nominal resources or virtual resources. As used herein, “nominal resource” or “virtual resource” may refer to a resource (e.g., a time-frequency resource or a radio resource) that is indicated or configured for the UE 120, but is not used for transmission (or is infrequently used for transmission) by the network node 110. In some aspects, the second set of resources may include one or more downlink reference signal resources (e.g., SSB resources or CSI-RS resources) that are infrequently used, or not used, for transmissions by the network node 110. In some other examples, the second set of resources may include one or more virtual resources or logical resources (e.g., resources that are not used for transmission by the network node 110).

In some aspects, a given resource (e.g., from the first set of resources and the second set of resources) may be associated with a beam. For example, the network node 110 may associated a given resource with a given beam. In the case where the resource is used for transmission by the network node 110, the network node 110 may transmit using the resource and the beam. In some aspects, the first set of resources may be associated with Set B beams of the network node 110 and the second set of resources may be associated with Set A beams of the network node 110. In some aspects, the first set of resources may be a subset of the second set of resources. In some other aspects, the first set of resources may include different resources (e.g., may be mutually exclusive sets).

In some aspects, the configuration information may include a CSI configuration. For example, the configuration information may include a CSI report setting and/or a CSI resource setting, among other examples. As another example, the configuration information may include a CSI-ReportConfig configuration and/or a CSI-ResourceConfig configuration, among other examples. In other words, the configuration information may configure the UE 120 to transmit a CSI report including information (e.g., measurements) associated with the first set of resources and the second set of resources. As described above, the first set of resources may be CMRs for the CSI report. In some aspects, the CSI configuration may include an indication that the UE 120 is to transmit a CSI report. For example, the CSI configuration may configure a periodic CSI report (e.g., that is to be transmitted periodically by the UE 120). In other examples, the CSI configuration may configure a semi-persistent CSI report (e.g., that is activated via a MAC-CE communication) or an aperiodic CSI report (e.g., that is triggered via a DCI communication).

In some aspects, the configuration information may indicate a report quantity configuration for the CSI report. For example, the UE 120 may be configured with a CSI-ReportConfig with the higher layer parameter reportQuantity set to either ‘none’, ‘cri-RI-PMI-CQI’, ‘cri-RI-il’, ‘cri-RI-il-CQI’, ‘cri-RI-CQI’, ‘cri-RSRP’, ‘ssb-Index-RSRP’ or ‘cri-RI-LI-PMI-COI’, among other examples (for example, as defined, or otherwise fixed, by the 3GPP). The report quantity may indicate or configure what is to be included in the CSI report and how the UE 120 is to expect to be configured for the CSI report, among other examples. In other words, the report quantity may indicate what kind of quantity (e.g., SSB RSRP, CQI, precoding matrix indicator (PMI), and/or rank indicator (RI)) should be measured and reported by the UE 120. For example, a wireless communication standard, such as the 3GPP, may define expectations and/or configurations for the CSI report for different values of the report quantity. In some aspects, a report quantity associated with the CSI report to be transmitted by the UE 120 may be based at least in part on the second set of resources (e.g., the nominal resources). For example, the second set of resources may be used to define the report quantity of the CSI configuration. In some aspects, the second set of resources may be used as references of report quantities in CSI reporting (e.g., the first set of resources may be used as CMRs for a CSI report, while the report quantities for the CSI report may be defined based at least in part on the second set of resources). For example, the UE 120 may receive a configuration (e.g., a CSI report setting, a CSI resource setting, a CSI-ReportConfig, and/or a CSI-ResourceConfig) for the CSI report. The configuration may indicate that the first set of resources are channel measurement resources associated with the CSI report and that the second set of resources are references associated with a report quantity associated with the CSI report.

In some aspects, the report quantity configuration may include an indication that the UE 120 is to report one or more measurement values from measurement values of the first set of resources and an indication of the resources associated with the one or more measurement values. Additionally, the report quantity configuration may include an indication that the UE 120 is to report an indication of one or more resources from the second set of resources that are selected based on the resources associated with the one or more measurement values. The report quantity configuration may include an indication that the UE 120 is to report an indication of predicted measurement values associated with the one or more resources from the second set of resources. For example, the report quantity of the CSI report may indicate that the UE 120 is to report (e.g., in a CSI report) identified resource ID(s) associated with one or more resources from the first set of resources, together with measured L1-RSRPs or L1-SINRs of the one or more resources. Additionally, the report quantity of the CSI report may indicate that the UE 120 is to report (e.g., in the CSI report) identified resource ID(s) associated with one or more resources from the second set of resources, together with predicted L1-RSRPs or L1-SINRs of the one or more resources. In some aspects, the report quantity of the CSI report may indicate that the UE 120 is to report (e.g., in the CSI report) identified Rx beam information (e.g., Rx beam information of the UE 120) associated with the identified one or more resources from the second set of resources.

In some aspects, the configuration information may include an indication of quantization levels associated with the information to be included in the CSI report. For example, the configuration information (e.g., the CSI configuration) may include an indication that the UE 120 is to report the measured L1-RSRPs or L1-SINRs of the one or more resources from the first set of resources using differential reporting. For example, the configuration information may indicate that the UE 120 is to report a highest measured measurement value as an absolute value (e.g., as an indication of the actual value) and other reported measurement values as differential values with respect to the absolute value. In other words, if the highest measurement value is X₁, and another measurement value to be reported is X₂, the configuration information may indicate that the UE 120 is to report an indication of X₁ and (X₁-X₂), thereby reducing a size of the CSI report (e.g., because the differential value may be indicated using a smaller size or less quantity of bits). In some aspects, the configuration information may include an indication of a size (e.g., a quantity of bits) to be used to report the absolute value and/or differential values.

Additionally, the configuration information may indicate that the UE 120 is to report predicted measurement values as differential values with respect to a reported measurement value. For example, a predicted measurement value may be associated with a resource from the second set of resources. The resource from the second set of resources may be connected to, mapped to, or otherwise associated with, a resource from the first set of resources, as described in more detail elsewhere herein. The resource from the first set of resources may be associated with a measurement value reported in the CSI report. The configuration information may indicate that the UE 120 is to report a predicted measurement value associated with the resource from the second set of resources as differential values with respect to the measurement value. For example, if the measurement value is reported as X and the predicted measurement value is Y₁, then the reported predicted measurement value may be (X₁−Y₁). As another example, if the measurement value is reported as (X₁−X₂) and the predicted measurement value is Y₁, then the reported predicted measurement value may be ((X₁−X₂)−Y₁) or (X₂−Y₁). In some aspects, the configuration information may include an indication of a size (e.g., a quantity of bits) to be used to report the predicted measurement values. Additional quantization details for the CSI report are depicted and described in more detail in connection with FIG. 7C.

For example, the UE 120 may receive a communication indicating one or more parameters associated with performing beam predictions associated with the CSI report. The one or more parameters may include a quantization and/or size (e.g., a quantity of bits) to be used to report the predicted measurement values and/or actual measurement values. As another example, the one or more parameters may include a report quantity of the CSI report. As another example, the one or more parameters may include a quantity of measurement values to be reported in the CSI report. The one or more parameters may include any configurable aspect of the CSI report as described herein. The communication (e.g., that indicates the one or more parameters) may be an RRC communication (e.g., may be a CSI report setting communication or a CSI resource setting communication). Additionally, or alternatively, the communication may include an RRC communication, a MAC-CE communication, and/or a DCI communication. In some aspects, the communication may include an RRC communication that indicates a first one or more parameters from the one or more parameters and a MAC-CE communication or DCI communication that indicates a second one or more parameters from the one or more parameters. In some aspects, such as for an aperiodic CSI report, at least one parameter from the one or more parameters may be indicated via a trigger state associated with the CSI report.

The UE 120 may configure itself based at least in part on the configuration information. In some aspects, the UE 120 may be configured to perform one or more operations described herein based at least in part on the configuration information.

As shown by reference number 715, the network node 110 may transmit, and the UE 120 may receive, an indication of a mapping (e.g., of one or more connections) between the first set of resources and the second set of resources. The mapping may indicate that each resource included in the second set of resources is associated with at least one resource included in the first set of resources. In some aspects, the mapping may indicate one or more connections between resource(s) included in the first set of resources and resource(s) included in the second set of resources. In some aspects, the one or more connections may be implicit connections. In some aspects, the indication of the mapping (e.g., of the one or more connections) may be included in the configuration information (e.g., the configuration information and the indication of the one or more connections may be included in the same communication or configuration). In some other aspects, the indication of one or more connections may be transmitted to the UE 120 separate from the configuration information.

For example, a connection associated with a resource, included in the first set of resources or the second set of resources, that may be defined with respect to one or more resources included in a different set of resources from the first set of resources or the second set of resources. In some aspects, the connection may indicate a relationship between a first spatial direction or a first beam associated with the resource and second spatial directions or second beams of the one or more resources included in the different set of resources. In other words, the connections may implicitly indicate beams and/or spatial directions associated with a given resource by connecting the given resource to one or more other resources included in a different set of resources.

As shown in FIG. 7B, in some aspects, a mapping 750 may indicate one or more connections between resources included in the different sets. In some aspects, a connection indicated by the mapping may indicate a spatial superposition relationship between a first spatial direction or a first beam associated with a resource and second spatial directions or second beams associated with the one or more resources included in the different set of resources (e.g., that are indicated as being connected with the resource by the mapping). In other words, a connection between a resource included in the first set of resources and a resource included in the second set of resources may indicate spatial superpositions among connected resources. For example, a connection may indicate that a first beam width of the first beam associated with the resource may be overlapping with second beam widths of the second beams. In other words, if the mapping indicates that a first resource (e.g., included in the second set of resources) is connected with a second resource (e.g., included in the first set of resources), then the UE 120 may assume the beam width associated the first resource is within the beam width associated with the second resource.

In some aspects, a beam width may include an angular spread that is associated with an attenuation difference from a peak beamforming gain, of a beam associated with the beam width, that satisfies a threshold (e.g., L decibels (dB) of attenuation). In other words, beam width may be defined as angular spread that is within L dB attenuation with respect to the peak beamforming gain of the beam. In some aspects, a value of the threshold (e.g., L) may be defined, or otherwise fixed, by a wireless communication standard, such as the 3GPP. Additionally, or alternatively, a value of the threshold (e.g., L) may be included in the indication of the one or more connections between the first set of resources and the second set of resources.

As an example, and as shown in FIG. 7B, the mapping may indicate that a resource 1 included in the second set of resources is connected to a resource 0 and a resource 1 included in the first set of resources. The connections may indicate spatial superpositions among the connected resources. For example, the connections may indicate that a beam width of a beam associated with the resource 1 included in the second set of resources is included within a beam width of a beam associated with the resource 0 included in the first set of resources and within a beam width of a beam associated with the resource 1 included in the first set of resources. From this information, the UE 120 may be enabled to extrapolate and/or perform predictions for the beam associated with the resource 1 in the first set of resources based at least in part on measurements of the resource 0 and the resource 1 that are included in the first set of resources, as described in more detail elsewhere herein.

In some aspects, the mapping and/or the connections between resources in the first set of resources and the second set of resources may be configured for a given CSI report (e.g., may be configured dedicated for CSI reports). For example, the connections may be specific to a given CSI report configuration. For example, for periodic or semi-persistent CSI reports, the connections may be indicated in a configuration for the CSI reports. For example, the UE 120 may receive a CSI report setting associated with the CSI report. The CSI report setting may include the indication of the one or more connections between the first set of resources and the second set of resources. As another example, the UE 120 may receive a CSI resource setting associated with the CSI report. The CSI resource setting may include the indication of the one or more connections between the first set of resources and the second set of resources. For example, the CSI resource setting may include an indication of the first set of resources, the second set of resources, and the connections between the first set of resources the second set of resources.

For semi-persistent CSI report, the UE 120 may receive a MAC-CE communication activating a transmission of the CSI report. In some aspects, the MAC-CE communication may include the indication of the one or more connections between the first set of resources and the second set of resources. As another example, for aperiodic CSI reports, the UE 120 may receive DCI triggering a triggering state associated with the CSI report. In some aspects, the triggering state may include the indication of the one or more connections between the first set of resources and the second set of resources. For example, the UE 120 may receive configurations (e.g., RRC configurations) for one or more triggering states that indicate respective connections between the first set of resources and the second set of resources. The UE 120 may receive DCI that triggers a given trigger state. The UE 120 may identify the connections between the first set of resources and the second set of resources based at least in part on a configuration of the given triggering state.

In some aspects, the connections may be configured irrespective of a CSI report configuration or setting. For example, the UE 120 may receive, and the network node 110 may transmit, an RRC configuration including information associated with respective resources from the first set of resources and the second set of resources. In some aspects, the RRC configuration may include the indication of the one or more connections between the first set of resources and the second set of resources. For example, the connections may be RRC configured by each respective information element of the first set of resources (e.g., an SSB information element or a CSI-RS information element) and/or the second set of resources.

In some aspects, the mapping 750 may indicate that resources included in the second set of resources are associated with a respective single resource from the first set of resources. In other words, a condition may restrict a mapping for a given resource included in the second set of resources such that the given resource is mapped to, or connected with, a single resource included in the first set of resources. For example, each resource included in the second set of resources may only be allowed to be connected with a single resource within the first set of resources. This may reduce a complexity associated with the UE 120 identifying an Rx beam to be associated with a prediction for the resource included in the second set of resources. For example, the UE 120 may be enabled to identify that an Rx beam to be associated with the prediction may be the Rx beam that is used to measure the single resource included in the first set of resources (e.g., if the resource included in the second set of resources were mapped to multiple resources included in the first set of resources there may be ambiguity as to which Rx beam is to be associated with the prediction).

In such examples, quasi co-location (QCL) relationships between resources included in the second set of resources and a respective single resource from the first set of resources may define a receive beam to be used to receive the resources included in the second set of resources. For example, each resource included in the second set of resources may have a QCL relationship with a single resource included in the first set of resources. In some aspects, the QCL relationship may be a QCL Type-D relationship (e.g., as defined, or otherwise fixed, by a wireless communication standard, such as the 3GPP). For example, a QCL Type-D relationship may include an indication of a spatial receive parameter that indicates the Rx beam (e.g., the spatial receive parameter may correspond to analog receive beamforming parameters of a UE receive beam).

In other examples, a receive beam associated with a first resource included in the second set of resources may be based at least in part on the receive beam being used by the UE 120 to measure a second resource, included in the first set of resources, that is associated with the first resource as indicated by the mapping. For example, in some cases, QCL relationship may not be defined for nominal or virtual resources (e.g., included in the second set of resources). In such examples, the predicted measurement value associated with a given resource included in the second set of resources may be based at least in part on the Rx beam used by the UE 120 for receiving a connected resource included in the first set of resources (e.g., the UE 120 may determine that the Rx beam would be used to receive the virtual resource in the second set of resources if the virtual resource were actually to be associated with a transmission). In such examples, the resource included in the second set of resources (e.g., the virtual resource) may be a QCL source resource for a transmission configuration indicator (TCI) state associated with the receive beam. For example, the (virtual) resources included in the second set of resources may be configured and/or indicated (e.g., by the network node 110) as being a QCL Type-D source for a TCI state. As a result, the UE 120 may identify which Rx beam is to be associated with the (virtual) resources included in the second set of resources (e.g., based at least in part on the prediction of measurement values of the (virtual) resources).

In some aspects, the mapping 750 may indicate that resources included in the second set of resources are associated with respective multiple resources from the first set of resources. In other words, a given resource included in the first set of resources may be associated with multiple resources included in the first set of resources (e.g., as shown in FIG. 7B). For example, a beamwidth of a resource included in the second set of resource may be within beamwidths of multiple resources included in the second set of resources. In such examples, a QCL relationship (e.g., a QCL Type-D relationship) may indicate a one-to-many relationship between a resource included in the second set of resources and multiple resources included in the first set of resources. In other examples, a resource included in the second set of resources may be configured as a QCL Type-D source for a TCI state that indicates one or more Rx beams to be associated with the resource (e.g., for a virtual resource to define an Rx beam to be used by the UE 120 if a beam associated with the virtual resource is actually used by the network node 110).

In examples where resources included in the second set of resources are associated with respective multiple resources from the first set of resources, the UE 120 may consider multiple Rx beams when predicting a measurement value associated with a given resource included in the second set of resources (and/or may predict multiple measurement values for respective Rx beams). For example, a first resource, from the second set of resources, may be associated with a second resource and a third resource from the first set of resources. Predicted measurement values for the first resource may be associated with a first predicted resource that is based at least in part on a first measurement value, from the one or more measurement values, that is associated with the second resource and a first receive beam used to measure the first measurement value. Additionally, predicted measurement values for the first resource may be associated with a second predicted resource that is based at least in part on a second measurement value, from the one or more measurement values, that is associated with the third resource and a second receive beam used to measure the second measurement value.

In other words, if a given resource included in the second set of resources is mapped to R resources included in the first set of resources, then the UE 120 may determine R predicted measurement values associated with the given resource. For example, given a certain identified resource included the first set of resources, the predicted measurement values associated with a resource included in the second set of resources (e.g., which may be connected with at least one another resource in the first set of resources), may be based at least in part on the UE 120 using a (virtually) same Rx beam used for receiving the identified resource in the first set of resources to receive the (virtual) resource in the second set of resources.

Returning to FIG. 7A, and as shown by reference number 720, the UE 120 may receive, and the network node 110 may transmit, an indication that the UE 120 is to transmit a CSI report. In some examples, the indication may be included in an RRC communication (e.g., such as in the configuration information described above in connection with reference number 710). Additionally, or alternatively, the indication may be included in a MAC-CE communication (e.g., for semi-persistent CSI reports) and/or a DCI communication (e.g., for aperiodic CSI reports).

As shown by reference number 725, the network node 110 may transmit, and the UE 120 may receive, one or more signals using the resources included in the first set of resources. For example, the network node 110 may transmit one or more downlink reference signals (e.g., SSBs or CSI-RSs) using the resources included in the first set of resources. In some aspects, the network node 110 may transmit the one or more signals as part of a beam management procedure (e.g., similar to a P1 beam management procedure as described in connection with FIG. 4). In some aspects, the network node 110 may not transmit resources included in the second set of resources. As shown by reference number 730, the UE 120 may perform measurements of the signals that are associated with the first set of resources. For example, the UE 120 may perform L1 RSRP measurements and/or L1 SINR measurements, among other examples, of the signals that are associated with the first set of resources. For example, the UE 120 may measure the one or more signals associated with resources included in the first set of resources to obtain a set of measurement values.

As shown by reference number 735, the UE 120 may select one or more resources from the second set of resources (e.g., to be associated with predicted measurements performed by the UE 120) based at least in part on the set of measurement values. For example, the UE 120 may identify one or more measurement values, from the set of measurement values, that are associated with highest measurement values among the set of measurement values. In some aspects, a quantity of the one or more measurement values may be configured (e.g., in the CSI configuration). The UE 120 may identify one or more resources, from the first set of resources, that are associated with the one or more (highest) measurement values. The UE 120 may identify resource(s), from the second set of resources, that are mapped to, or connected with, the one or more resources from the first set of resources (e.g., as indicated by the mapping 750). The UE 120 may select the identified resources from the second set of resources to be associated with predicted measurements performed by the UE 120.

This may enable the UE 120 to perform predictions for resources that are likely to be associated with higher measurement values (e.g., because the resources are mapped to, or connected with, resources associated with the one or more (highest) measurement values obtained by the UE 120). Additionally, this may conserve processing resources and/or power resources of the UE 120 that would have otherwise been used to perform predictions for each resource included in the second set of resources.

As shown by reference number 740, the UE 120 may determine predicted measurement values associated with the one or more selected resources from the second set of resources (e.g., based at least in part on the one or more measurement values and/or the mapping 750). For example, the UE 120 may input the measurements performed by the UE 120 and indication(s) of the connections (or beam/spatial information determined by the UE 120 based at least in part on the connection) to an AI/ML model. The AI/ML model may output predicted measurement values associated with the second set of resources, as described in more detail elsewhere herein. The predicted measurement values may be predicted L1 RSRP values and/or predicted L1 SINR values, among other examples.

For example, the UE 120 may identify the one or more measurement values based on a highest one or more measurement values from the set of measurement values. The UE 120 may predict, for each resource included in the selected one or more resources and based at least in part on at least one measurement value from the one or more measurement values, predicted measurement values for each resource, included in the second one or more resources, that are associated with each resource included in the first one or more resources. For example, for a given resource, included in the selected one or more resources, the UE 120 may identify a resource, from the first set of resources, that is mapped to and/or connected with the given resource. The UE 120 may input information associated with the connection between the given resource and the identified resource and a measurement value of the identified resource into the AI/ML model. The AI/ML model may output a predicted measurement value associated with the given resource.

The UE 120 may identify one or more highest predicted measurement values from the predictions performed by the UE 120. In other words, the predicted measurement values reported by the UE 120 (e.g., in the CSI report, as described in more detail elsewhere herein) may be a highest one or more predicted measurement values from the predicted measurement values. For example, for each strongest beam identified in a Set B beams (e.g., associated with the first set of resources), the UE 120 may predict and/or report one or more connected beams in the Set A beams (e.g., associated with the second set of resources) together with predicted measurement values of the connected beams. In some aspects, for each connected beam in the Set A beams, the UE 120 may identify, predict measurement values, and/or report an indication of (and/or a predicted measurement value of) an Rx beam in connection with the predicted measurement values of the connected beams.

For example, the UE 120 may first identify one or more resource(s) included in the first set of resources associated with measurement values that are the strongest among all the resources included in the first set of resources. For each resource associated with the strongest measurements that are identified from the first set of resources, the UE 120 may identify one or more resource(s), included in the second set of resources, associated with predicted measurement values are the strongest among resources, included in the second set of resources, that are connected with the identified resource in the first set of resources. In some aspects, for each resource identified in the second set of resources, the UE 120 may identify a predicted Rx beam associated with the resource. Predicting the Rx beam may be optional and may be performed by the UE 120 based at least in part on a capability of the UE 120 and/or the CSI configuration indicated by the network node 110.

As shown by reference number 745, the UE 120 may transmit, and the network node 110 may receive, a CSI report. In some aspects, the CSI report may indicate one or more measurement values from the set of measurement values (e.g., the highest one or more measurement values from the set of measurement values associated with the first set of resources). Additionally, the CSI report may indicate a first one or more resources, from the first set of resources, that are associated with the one or more measurement values (e.g., may indicate identifiers associated with the first one or more resources). Additionally, the CSI report may indicate a second one or more resources (e.g., resource identifiers), from the second set of resources, that are selected based on the first one or more resources and the mapping 750 (e.g., as described above in connection with reference number 735). Additionally, the CSI report may indicate one or more predicted measurement values associated with the second one or more resources. In some aspects, the CSI report may indicate a receive beam (e.g., a predicted receive beam) associated with the UE 120 for each resource included in the second one or more resources (e.g., if the UE 120 is capable of and/or configured to predict receive beams for the selected resources included in the second set of resources).

In other words, the UE 120 may indicate, in the CSI report, resource identifiers of the first one or more resources (e.g., from the first set of resources) along with the one or more measurement values associated with the first one or more resources. Additionally, the UE 120 may indicate, in the CSI report, resource identifiers of the second one or more resources (e.g., from the second set of resources) along with the one or more predicted measurement values. In some aspects, the UE 120 may indicate, in the CSI report, Rx beam information associated with the selected resources included in the second set of resources (e.g., the second one or more resources).

As shown in FIG. 7C, the UE 120 may report the one or more measurement values and the one or more predicted measurement values using a hierarchical quantization technique. For example, as shown by reference number 755, the UE 120 may include an indication of an absolute measurement value (e.g., an actual measurement value) in the CSI report. For example, the CSI report may include an indication of a highest measurement value, from the one or more measurement values (e.g., as an absolute or actual value). As shown by reference number 760, the UE 120 may include an indication of one or more differential values with respect to the absolute measurement value in the CSI report. For example, the CSI report may include an indication of one or more indications of remaining measurement values, from the one or more measurement values, as differential values with respect to the highest measurement value. As described elsewhere herein, a differential value may indicate a difference between a first value and a second value. Because a differential measurement value may be a smaller value that an actual or absolute measurement value, this may reduce a size (e.g., a quantity of bits) used to indicate the measurement value, thereby reducing a size of the CSI report. For example, the absolute measurement value may be indicated by the UE 120 using N/bits and each of the differential measurement values may be indicated by the UE 120 using N₂ bits (e.g., where N₁>N₂).

As shown by reference number 765, the UE 120 may include an indication of the one or more predicted measurement values as differential values in the CSI report. For example, the CSI report may include one or more indications of the one or more predicted measurement values as differential values with respect to respective measurement values from the one or more measurement values that are associated with the one or more predicted measurement values as indicated by the mapping. For example, as shown in FIG. 7C, resources associated with the prediction 1, the prediction 2, and the prediction 3 may be connected with a resource associated with the measurement 1. Therefore, the prediction 1, the prediction 2, and the prediction 3 may be indicated as differential values with respect to a measurement value of the measurement 1. As another example, resources associated with the prediction 4, the prediction 5, and the prediction 6 may be connected with a resource associated with the measurement 2. Therefore, the prediction 5, and the prediction 6 may be indicated as differential values with respect to a measurement value of the measurement 2. Each of the predicted measurement values may be indicated by the UE 120 using N₃ bits. Values of N₁, N₂, and/or N₃ may be defined, or otherwise fixed, by a wireless communication standard, such as the 3GPP. Additionally, or alternatively, values of N₁, N₂, and/or N₃ may be configured or otherwise indicated to the UE 120 by the network node 110 (e.g., in the configuration information and/or the CSI configuration).

In some aspects, the indication of the highest measurement value may be associated with a first size (e.g., N₁ bits). Each indication, from the one or more indications of remaining measurement values, may be associated with a second size (e.g., N₂ bits). Each indication, from the one or more indications of the one or more predicted measurement values, may be associated with a third size (e.g., N₃ bits). In some aspects, the UE 120 may receive, and the network node 110 may transmit, an indication of the first size, the second size, and/or the third size (e.g., in the configuration information and/or the CSI configuration). As an example, N₁ bits may include 7 bits, N₂ bits may include 4 bits, and N₃ bits may include 2 bits. This may reduce a size of the CSI report and conserve signaling overhead that would have otherwise been used to report absolute or actual values for each of the measurement values and the predicted measurement values.

In some aspects, indications, from the one or more indications of the one or more predicted measurement values, associated with a measurement value, from the one or more measurement values may include a first indication, associated with a first size, of a first predicted measurement value as a differential value with respect to the measurement value and a second indication, associated with a second size, of a second predicted measurement value as a differential value with respect to the measurement value. In other words, different quantization granularities may be used to report predicted measurement values associated with the second set of resources. For example, predicted measurement values associated with the same resource included in the first set of resources may be reported using different size (e.g., different quantities of bits). For example, a highest predicted measurement value associated with a given resource included in the first set of resources may be reported, in the CSI report, using a first size and other predicted measurement value associated with the given resource may be reported, in the CSI report, using a second size. In some aspects, the different quantization granularities (e.g., different sizes) may be used to report predicted measurement values associated with the highest measurement value (e.g., the absolute measurement value). In some aspects, each predicted measurement value associated with other measurement values (e.g., measurement values shown by reference number 760) may be associated with a same size (e.g., N₃ bits). In some aspects, a first one or more indications, from the one or more indications of the one or more predicted measurement values, associated with a first measurement value, from the one or more measurement values, may be associated with a first size. A second one or more indications, from the one or more indications of the one or more predicted measurement values, associated with a second measurement value, from the one or more measurement values, may be associated with a second size. This may enable additional information and/or detail to be reported for predictions associated with the highest measurement value while also reducing an overall size of the CSI report.

Additionally, or alternatively, a first one or more indications, from the one or more indications of the one or more predicted measurement values, associated with a first measurement value, from the one or more measurement values, may include a first quantity of indications of predicted measurement values. A second one or more indications, from the one or more indications of the one or more predicted measurement values, associated with a second measurement value, from the one or more measurement values, may include a second quantity of indications of predicted measurement values. In other words, for different resources included in the first set of resources, the UE 120 may report different quantities of predicted measurement values. For example, for predicted measurement values associated with the highest measurement value (e.g., shown by reference number 755), the UE 120 may report a first quantity of predicted measurement values and for other measurement values (e.g., shown by reference number 760), the UE 120 may report a second quantity of predicted measurement values.

In some aspects, the UE 120 may report more predicted measurement values for resources associated with higher measurement values. For example, for the highest measurement value, the UE 120 may report (e.g., in the CSI report) a first quantity of predicted measurement values. For a next highest measurement value, the UE 120 may report (e.g., in the CSI report) a second quantity of predicted measurement values (e.g., that is less than the first quantity). For a next highest measurement value, the UE 120 may report (e.g., in the CSI report) a third quantity of predicted measurement values (e.g., that is less than the second quantity). In some aspects, the UE 120 may report different quantities of predicted measurement values for different resources included in the first set of resources in addition to using different quantization granularities for predicted measurement values associated with a given resource included in the first set of resources. This may enable additional information and/or detail to be reported for predictions associated with the highest measurement value while also reducing an overall size of the CSI report.

As a result, the UE 120 and/or a network node 110 may conserve signaling overhead, network resources, processing resources, and/or power resources that would have otherwise been used associated with performing one or more beam refinement procedures. For example, predicted beam measurements for a beam refinement procedure may be obtained via one or more measurements (e.g., of Set B beams) and a configured mapping between a first set of resources (e.g., associated with Set B beams) and a second set of resources (e.g., associated with Set A beams). As a result, the UE 120 may be enabled to perform improved predictive beam management by obtaining beam characteristics (e.g., beam shape and/or beam width) associated with the first set of resources and the second set of resources. Moreover, the UE 120 may be enabled to identify Tx beams of a network node 110 and/or Rx beams of the UE 120 that are to be associated with predicted beam measurements (e.g., based on measurements of the first set of resources), thereby conserving network resources, processing resources, and/or power resources that would have otherwise been used to predict and/or indicate measurement predictions for all resources included in the second set of resources.

As indicated above, FIGS. 7A-7C are provided as examples. Other examples may differ from what is described with regard to FIGS. 7A-7C.

FIG. 8 is a diagram illustrating an example process 800 performed, for example, by a UE, in accordance with the present disclosure. Example process 800 is an example where the UE (e.g., UE 120) performs operations associated with beam management procedures using predicted beam measurements.

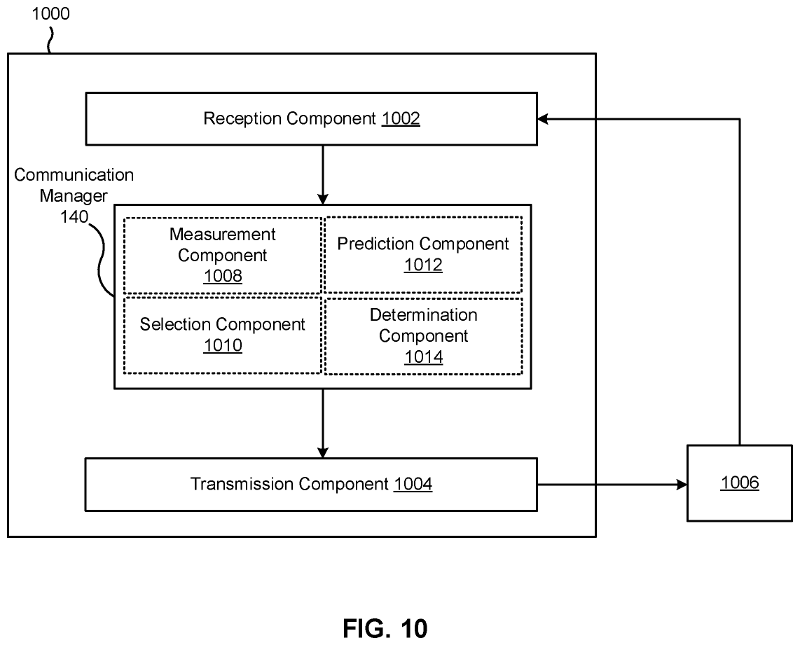

As shown in FIG. 8, in some aspects, process 800 may include receiving, from a network node, an indication to transmit a CSI report, wherein the CSI report is associated with a first set of resources and a second set of resources, and wherein a mapping indicates that each resource included in the second set of resources is associated with at least one resource included in the first set of resources (block 810). For example, the UE (e.g., using communication manager 140 and/or reception component 1002, depicted in FIG. 10) may receive, from a network node, an indication to transmit a CSI report, wherein the CSI report is associated with a first set of resources and a second set of resources, and wherein a mapping indicates that each resource included in the second set of resources is associated with at least one resource included in the first set of resources, as described in connection with FIGS. 7A-7C.

As further shown in FIG. 8, in some aspects, process 800 may include measuring one or more signals associated with resources included in the first set of resources to obtain a set of measurement values (block 820). For example, the UE (e.g., using communication manager 140 and/or measurement component 1008, depicted in FIG. 10) may measure one or more signals associated with resources included in the first set of resources to obtain a set of measurement values, as described above.

As further shown in FIG. 8, in some aspects, process 800 may optionally include selecting a second one or more resources, from the second set of resources, based at least in part on a first one or more resources, from the first set of resources that are associated with the one or more measurement values from the set of measurement values (block 830). For example, the UE (e.g., using communication manager 140 and/or selection component 1010, depicted in FIG. 10) may select a second one or more resources, from the second set of resources, based at least in part on a first one or more resources, from the first set of resources that are associated with the one or more measurement values from the set of measurement values, as described in connection with FIGS. 7A-7C.

As further shown in FIG. 8, in some aspects, process 800 may optionally include predicting one or more measurement values for the second one or more resources based at least in part on the one or more measurement values and the mapping (block 840). For example, the UE (e.g., using communication manager 140 and/or prediction component 1012, depicted in FIG. 10) may predict one or more measurement values for the second one or more resources based at least in part on the one or more measurement values and the mapping, as described in connection with FIGS. 7A-7C.

As further shown in FIG. 8, in some aspects, process 800 may include transmitting, to the network node, the CSI report indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources (block 850). For example, the UE (e.g., using communication manager 140 and/or transmission component 1004, depicted in FIG. 10) may transmit, to the network node, the CSI report indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources, as described in connection with FIGS. 7A-7C.

Process 800 may include additional aspects, such as any single aspect or any combination of aspects described below and/or in connection with one or more other processes described elsewhere herein.

In a first aspect, process 800 includes identifying the one or more measurement values based on a highest one or more measurement values from the set of measurement values, and predicting, for each resource included in the first one or more resources and based at least in part on at least one measurement value from the one or more measurement values, predicted measurement values for each resource, included in the second one or more resources, that are associated with each resource included in the first one or more resources, wherein the one or more predicted measurement values are a highest one or more predicted measurement values from the predicted measurement values.

In a second aspect, alone or in combination with the first aspect, the CSI report indicates a receive beam associated with the UE for each resource included in the second one or more resources.

In a third aspect, alone or in combination with one or more of the first and second aspects, the first set of resources are associated with a first set of downlink reference signals, and wherein the second set of resources are associated with a second set of downlink reference signals or a set of virtual resources.

In a fourth aspect, alone or in combination with one or more of the first through third aspects, the mapping indicates that resources included in the second set of resources are associated with a respective single resource from the first set of resources.

In a fifth aspect, alone or in combination with one or more of the first through fourth aspects, QCL relationships between resources included in the second set of resources and a respective single resource from the first set of resources defines a receive beam to be used to receive the resources included in the second set of resources.

In a sixth aspect, alone or in combination with one or more of the first through fifth aspects, a receive beam associated with a first resource included in the second set of resources is based at least in part on the receive beam being used by the UE to measure a second resource, included in the first set of resources, that is associated with the first resource as indicated by the mapping.

In a seventh aspect, alone or in combination with one or more of the first through sixth aspects, the first resource is a QCL source resource for a TCI state associated with the receive beam.

In an eighth aspect, alone or in combination with one or more of the first through seventh aspects, the mapping indicates that resources included in the second set of resources are associated with respective multiple resources from the first set of resources.

In a ninth aspect, alone or in combination with one or more of the first through eighth aspects, a first resource, from the second set of resources, is associated with a second resource and a third resource from the first set of resources, and wherein the one or more predicted measurement values are associated with a first predicted resource that is based at least in part on a first measurement value, from the one or more measurement values, that is associated with the second resource and a first receive beam used to measure the first measurement value, and a second predicted resource that is based at least in part on a second measurement value, from the one or more measurement values, that is associated with the third resource and a second receive beam used to measure the second measurement value.

In a tenth aspect, alone or in combination with one or more of the first through ninth aspects, the CSI report comprises an indication of a highest measurement value, from the one or more measurement values, one or more indications of remaining measurement values, from the one or more measurement values, as differential values with respect to the highest measurement value, and one or more indications of the one or more predicted measurement values as differential values with respect to respective measurement values from the one or more measurement values that are associated with the one or more predicted measurement values as indicated by the mapping.

In an eleventh aspect, alone or in combination with one or more of the first through tenth aspects, the indication of the highest measurement value is associated with a first size, wherein each indication, from the one or more indications of remaining measurement values, is associated with a second size, and wherein each indication, from the one or more indications of the one or more predicted measurement values, is associated with a third size.

In a twelfth aspect, alone or in combination with one or more of the first through eleventh aspects, process 800 includes receiving, from the network node, an indication of at least one of the first size, the second size, or the third size.

In a thirteenth aspect, alone or in combination with one or more of the first through twelfth aspects, indications, from the one or more indications of the one or more predicted measurement values, associated with a measurement value, from the one or more measurement values, include a first indication, associated with a first size, of a first predicted measurement value as a differential value with respect to the measurement value, and a second indication, associated with a second size, of a second predicted measurement value as a differential value with respect to the measurement value.

In a fourteenth aspect, alone or in combination with one or more of the first through thirteenth aspects, a first one or more indications, from the one or more indications of the one or more predicted measurement values, associated with a first measurement value, from the one or more measurement values, are associated with a first size, and wherein a second one or more indications, from the one or more indications of the one or more predicted measurement values, associated with a second measurement value, from the one or more measurement values, are associated with a second size.

In a fifteenth aspect, alone or in combination with one or more of the first through fourteenth aspects, a first one or more indications, from the one or more indications of the one or more predicted measurement values, associated with a first measurement value, from the one or more measurement values, include a first quantity of indications of predicted measurement values, and wherein a second one or more indications, from the one or more indications of the one or more predicted measurement values, associated with a second measurement value, from the one or more measurement values, include a second quantity of indications of predicted measurement values.

In a sixteenth aspect, alone or in combination with one or more of the first through fifteenth aspects, receiving the indication to transmit the CSI report comprises receiving a communication indicating one or more parameters associated with performing beam predictions associated with the CSI report.

In a seventeenth aspect, alone or in combination with one or more of the first through sixteenth aspects, the communication is a CSI report setting communication or a CSI resource setting communication.

In an eighteenth aspect, alone or in combination with one or more of the first through seventeenth aspects, the communication is at least one of a radio resource control communication, a MAC control element communication, or a downlink control information communication.

In a nineteenth aspect, alone or in combination with one or more of the first through eighteenth aspects, the communication includes a radio resource control communication that indicates a first one or more parameters from the one or more parameters, and a MAC control element communication or a downlink control information communication that indicates a second one or more parameters from the one or more parameters.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with beam management procedures using predicted beam measurements.

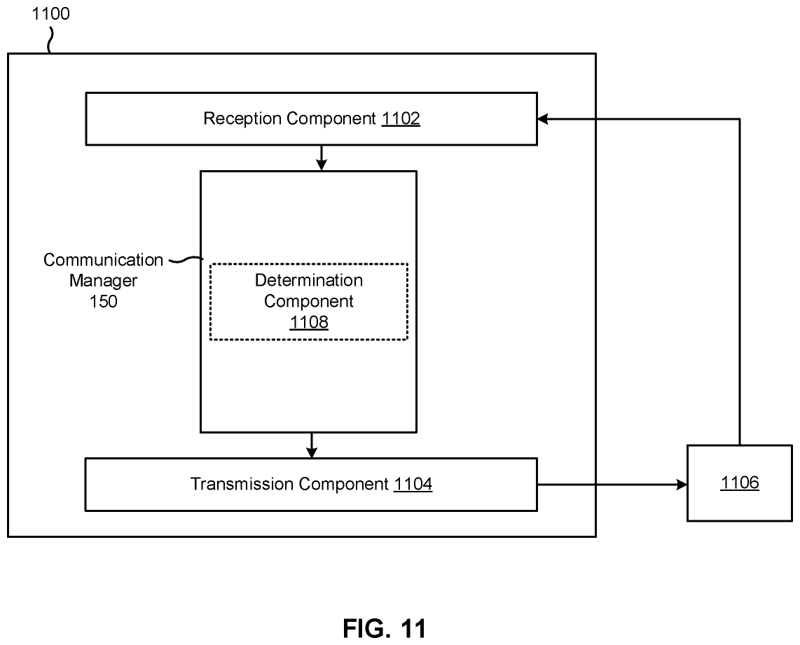

As shown in FIG. 9, in some aspects, process 900 may include transmitting an indication that a UE is to transmit a CSI report, wherein the CSI report is associated with a first set of resources and a second set of resources, and wherein a mapping indicates that each resource included in the second set of resources is associated with at least one resource included in the first set of resources (block 910). For example, the network node (e.g., using communication manager 150 and/or transmission component 1104, depicted in FIG. 11) may transmit an indication that a UE is to transmit a CSI report, wherein the CSI report is associated with a first set of resources and a second set of resources, and wherein a mapping indicates that each resource included in the second set of resources is associated with at least one resource included in the first set of resources, as described above.

As further shown in FIG. 9, in some aspects, process 900 may include receiving the CSI report, associated with the UE, indicating: one or more measurement values from a set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources (block 920). For example, the network node (e.g., using communication manager 150 and/or reception component 1102, depicted in FIG. 11) may receive the CSI report, associated with the UE, indicating: one or more measurement values from a set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources, as described above.

Process 900 may include additional aspects, such as any single aspect or any combination of aspects described below and/or in connection with one or more other processes described elsewhere herein.

In a first aspect, the CSI report indicates a receive beam associated with the UE for each resource included in the second one or more resources.

In a second aspect, alone or in combination with the first aspect, the first set of resources are associated with a first set of downlink reference signals, and wherein the second set of resources are associated with a second set of downlink reference signals or a set of virtual resources.

In a third aspect, alone or in combination with one or more of the first and second aspects, the mapping indicates that resources included in the second set of resources are associated with a respective single resource from the first set of resources.

In a fourth aspect, alone or in combination with one or more of the first through third aspects, QCL relationships between resources included in the second set of resources and a respective single resource from the first set of resources defines a receive beam of the UE to be used to receive the resources included in the second set of resources.

In a fifth aspect, alone or in combination with one or more of the first through fourth aspects, a receive beam of the UE associated with a first resource included in the second set of resources is based at least in part on the receive beam being used by the UE to measure a second resource, included in the first set of resources, that is associated with the first resource as indicated by the mapping.

In a sixth aspect, alone or in combination with one or more of the first through fifth aspects, the first resource is a QCL source resource for a TCI state associated with the receive beam.

In a seventh aspect, alone or in combination with one or more of the first through sixth aspects, the mapping indicates that resources included in the second set of resources are associated with respective multiple resources from the first set of resources.

In an eighth aspect, alone or in combination with one or more of the first through seventh aspects, a first resource, from the second set of resources, is associated with a second resource and a third resource from the first set of resources, and wherein the one or more predicted measurement values are associate with a first predicted resource that is based at least in part on a first measurement value, from the one or more measurement values, that is associated with the second resource and a first receive beam used to measure the first measurement value, and a second predicted resource that is based at least in part on a second measurement value, from the one or more measurement values, that is associated with the third resource and a second receive beam used to measure the second measurement value.

In a ninth aspect, alone or in combination with one or more of the first through eighth aspects, the CSI report comprises an indication of a highest measurement value, from the one or more measurement values, one or more indications of remaining measurement values, from the one or more measurement values, as differential values with respect to the highest measurement value, and one or more indications of the one or more predicted measurement values as differential values with respect to respective measurement values from the one or more measurement values that are associated with the one or more predicted measurement values as indicated by the mapping.

In a tenth aspect, alone or in combination with one or more of the first through ninth aspects, the indication of the highest measurement value is associated with a first size, wherein each indication, from the one or more indications of remaining measurement values, is associated with a second size, and wherein each indication, from the one or more indications of the one or more predicted measurement values, is associated with a third size.

In an eleventh aspect, alone or in combination with one or more of the first through tenth aspects, process 900 includes transmitting an indication of at least one of the first size, the second size, or the third size.

In a twelfth aspect, alone or in combination with one or more of the first through eleventh aspects, indications, from the one or more indications of the one or more predicted measurement values, associated with a measurement value, from the one or more measurement values includes a first indication, associated with a first size, of a first predicted measurement value as a differential value with respect to the measurement value, and a second indication, associated with a second size, of a second predicted measurement value as a differential value with respect to the measurement value.

In a thirteenth aspect, alone or in combination with one or more of the first through twelfth aspects, a first one or more indications, from the one or more indications of the one or more predicted measurement values, associated with a first measurement value, from the one or more measurement values, are associated with a first size, and wherein a second one or more indications, from the one or more indications of the one or more predicted measurement values, associated with a second measurement value, from the one or more measurement values, are associated with a second size.

In a fourteenth aspect, alone or in combination with one or more of the first through thirteenth aspects, a first one or more indications, from the one or more indications of the one or more predicted measurement values, associated with a first measurement value, from the one or more measurement values, include a first quantity of indications of predicted measurement values, and wherein a second one or more indications, from the one or more indications of the one or more predicted measurement values, associated with a second measurement value, from the one or more measurement values, include a second quantity of indications of predicted measurement values.

In a fifteenth aspect, alone or in combination with one or more of the first through fourteenth aspects, transmitting the indication that the UE is to transmit the CSI report comprises transmitting a communication indicating one or more parameters associated with performing beam predictions associated with the CSI report.

In a sixteenth aspect, alone or in combination with one or more of the first through fifteenth aspects, the communication is a CSI report setting communication or a CSI resource setting communication.

In a seventeenth aspect, alone or in combination with one or more of the first through sixteenth aspects, the communication is at least one of a radio resource control communication, a MAC control element communication, or a downlink control information communication.

In an eighteenth aspect, alone or in combination with one or more of the first through seventeenth aspects, the communication includes a radio resource control communication that indicates a first one or more parameters from the one or more parameters, and a MAC control element communication or a downlink control information communication that indicates a second one or more parameters from the one or more parameters.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a measurement component 1008, a selection component 1010, a prediction component 1012, and/or a determination component 1014, among other examples.

In some aspects, the apparatus 1000 may be configured to perform one or more operations described herein in connection with FIGS. 7A-7C. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network node, an indication to transmit a CSI report, wherein the CSI report is associated with a first set of resources and a second set of resources, and wherein a mapping indicates that each resource included in the second set of resources is associated with at least one resource included in the first set of resources. The measurement component 1008 may measure one or more signals associated with resources included in the first set of resources to obtain a set of measurement values. The transmission component 1004 may transmit, to the network node, the CSI report indicating one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

The selection component 1010 may select the second one or more resources, from the second set of resources, selected based on the first one or more resources and the mapping.

The determination component 1014 may identify the one or more measurement values based on a highest one or more measurement values from the set of measurement values.

The prediction component 1012 may predict, for each resource included in the first one or more resources and based at least in part on at least one measurement value from the one or more measurement values, predicted measurement values for each resource, included in the second one or more resources, that are associated with each resource included in the first one or more resources wherein the one or more predicted measurement values are a highest one or more predicted measurement values from the predicted measurement values.

The reception component 1002 may receive, from the network node, an indication of at least one of the first size, the second size, or the third size.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIGS. 7A-7C. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit an indication that a UE is to transmit a CSI report, wherein the CSI report is associated with a first set of resources and a second set of resources, and wherein a mapping indicates that each resource included in the second set of resources is associated with at least one resource included in the first set of resources. The reception component 1102 may receive the CSI report, associated with the UE, indicating one or more measurement values from a set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

The determination component 1108 may determine one or more parameters associated with performing beam predictions associated with the CSI report. The transmission component 1104 may transmit an indication of the one or more parameters.

The transmission component 1104 may transmit an indication of at least one of a first size associated with an indication of a highest measurement value, a second size associated with indications of remaining measurement values, from the one or more measurement values, that are to be reported as differential values with respect to the highest measurement value, or a third size associated with indications of the one or more predicted measurement values that are to be reported as differential values with respect to respective measurement values from the one or more measurement values that are associated with the one or more predicted measurement values as indicated by the mapping.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by an apparatus of a user equipment (UE), comprising: receiving, from a network node, an indication to transmit a channel state information (CSI) report, wherein the CSI report is associated with a first set of resources and a second set of resources, and wherein a mapping indicates that each resource included in the second set of resources is associated with at least one resource included in the first set of resources; measuring one or more signals associated with resources included in the first set of resources to obtain a set of measurement values; and transmitting, to the network node, the CSI report indicating: one or more measurement values from the set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Aspect 2: The method of Aspect 1, further comprising: identifying the one or more measurement values based on a highest one or more measurement values from the set of measurement values; and predicting, for each resource included in the first one or more resources and based at least in part on at least one measurement value from the one or more measurement values, predicted measurement values for each resource, included in the second one or more resources, that are associated with each resource included in the first one or more resources, wherein the one or more predicted measurement values are a highest one or more predicted measurement values from the predicted measurement values.

Aspect 3: The method of any of Aspects 1-2, wherein the CSI report indicates a receive beam associated with the UE for each resource included in the second one or more resources.

Aspect 4: The method of any of Aspects 1-3, wherein the first set of resources are associated with a first set of downlink reference signals, and wherein the second set of resources are associated with a second set of downlink reference signals or a set of virtual resources.

Aspect 5: The method of any of Aspects 1-4, wherein the mapping indicates that resources included in the second set of resources are associated with a respective single resource from the first set of resources.

Aspect 6: The method of any of Aspects 1-5, wherein quasi co-location (QCL) relationships between resources included in the second set of resources and a respective single resource from the first set of resources defines a receive beam to be used to receive the resources included in the second set of resources.

Aspect 7: The method of any of Aspects 1-6, wherein a receive beam associated with a first resource included in the second set of resources is based at least in part on the receive beam being used by the UE to measure a second resource, included in the first set of resources, that is associated with the first resource as indicated by the mapping.

Aspect 8: The method of Aspect 7, wherein the first resource is a quasi co-location (QCL) source resource for a transmission configuration indicator (TCI) state associated with the receive beam.

Aspect 9: The method of any of Aspects 1-8, wherein the mapping indicates that resources included in the second set of resources are associated with respective multiple resources from the first set of resources.

Aspect 10: The method of any of Aspects 1-9, wherein a first resource, from the second set of resources, is associated with a second resource and a third resource from the first set of resources, and wherein the one or more predicted measurement values are associated with: a first predicted resource that is based at least in part on a first measurement value, from the one or more measurement values, that is associated with the second resource and a first receive beam used to measure the first measurement value; and a second predicted resource that is based at least in part on a second measurement value, from the one or more measurement values, that is associated with the third resource and a second receive beam used to measure the second measurement value.

Aspect 11: The method of any of Aspects 1-10, wherein the CSI report comprises: an indication of a highest measurement value, from the one or more measurement values; one or more indications of remaining measurement values, from the one or more measurement values, as differential values with respect to the highest measurement value; and one or more indications of the one or more predicted measurement values as differential values with respect to respective measurement values from the one or more measurement values that are associated with the one or more predicted measurement values as indicated by the mapping.

Aspect 12: The method of Aspect 11, wherein the indication of the highest measurement value is associated with a first size, wherein each indication, from the one or more indications of remaining measurement values, is associated with a second size, and wherein each indication, from the one or more indications of the one or more predicted measurement values, is associated with a third size.

Aspect 13: The method of Aspect 12, further comprising: receiving, from the network node, an indication of at least one of the first size, the second size, or the third size.

Aspect 14: The method of any of Aspects 11-13, wherein indications, from the one or more indications of the one or more predicted measurement values, associated with a measurement value, from the one or more measurement values, include: a first indication, associated with a first size, of a first predicted measurement value as a differential value with respect to the measurement value; and a second indication, associated with a second size, of a second predicted measurement value as a differential value with respect to the measurement value.

Aspect 15: The method of any of Aspects 11-14, wherein a first one or more indications, from the one or more indications of the one or more predicted measurement values, associated with a first measurement value, from the one or more measurement values, are associated with a first size; and wherein a second one or more indications, from the one or more indications of the one or more predicted measurement values, associated with a second measurement value, from the one or more measurement values, are associated with a second size.

Aspect 16: The method of any of Aspects 11-15, wherein a first one or more indications, from the one or more indications of the one or more predicted measurement values, associated with a first measurement value, from the one or more measurement values, include a first quantity of indications of predicted measurement values; and wherein a second one or more indications, from the one or more indications of the one or more predicted measurement values, associated with a second measurement value, from the one or more measurement values, include a second quantity of indications of predicted measurement values.

Aspect 17: The method of any of Aspects 1-16, wherein receiving the indication to transmit the CSI report comprises: receiving a communication indicating one or more parameters associated with performing beam predictions associated with the CSI report.

Aspect 18: The method of Aspect 17, wherein the communication is a CSI report setting communication or a CSI resource setting communication.

Aspect 19: The method of any of Aspects 17-18, wherein the communication is at least one of a radio resource control communication, a medium access control (MAC) control element communication, or a downlink control information communication.

Aspect 20: The method of any of Aspects 17-19, wherein the communication includes: a radio resource control communication that indicates a first one or more parameters from the one or more parameters; and a medium access control (MAC) control element communication or a downlink control information communication that indicates a second one or more parameters from the one or more parameters.

Aspect 21: A method of wireless communication performed by an apparatus of a network node, comprising: transmitting an indication that a user equipment (UE) is to transmit a channel state information (CSI) report, wherein the CSI report is associated with a first set of resources and a second set of resources, and wherein a mapping indicates that each resource included in the second set of resources is associated with at least one resource included in the first set of resources; and receiving the CSI report, associated with the UE, indicating: one or more measurement values from a set of measurement values, a first one or more resources, from the first set of resources, that are associated with the one or more measurement values, a second one or more resources, from the second set of resources, that are selected based on the first one or more resources and the mapping, and one or more predicted measurement values associated with the second one or more resources.

Aspect 22: The method of Aspect 21, wherein the CSI report indicates a receive beam associated with the UE for each resource included in the second one or more resources.

Aspect 23: The method of any of Aspects 21-22, wherein the first set of resources are associated with a first set of downlink reference signals, and wherein the second set of resources are associated with a second set of downlink reference signals or a set of virtual resources.

Aspect 24: The method of any of Aspects 21-23, wherein the mapping indicates that resources included in the second set of resources are associated with a respective single resource from the first set of resources.

Aspect 25: The method of any of Aspects 21-24, wherein quasi co-location (QCL) relationships between resources included in the second set of resources and a respective single resource from the first set of resources defines a receive beam of the UE to be used to receive the resources included in the second set of resources.

Aspect 26: The method of any of Aspects 21-25, wherein a receive beam of the UE associated with a first resource included in the second set of resources is based at least in part on the receive beam being used by the UE to measure a second resource, included in the first set of resources, that is associated with the first resource as indicated by the mapping.

Aspect 27: The method of Aspect 26, wherein the first resource is a quasi co-location (QCL) source resource for a transmission configuration indicator (TCI) state associated with the receive beam.

Aspect 28: The method of any of Aspects 21-27, wherein the mapping indicates that resources included in the second set of resources are associated with respective multiple resources from the first set of resources.

Aspect 29: The method of any of Aspects 21-28, wherein a first resource, from the second set of resources, is associated with a second resource and a third resource from the first set of resources, and wherein the one or more predicted measurement values are associate with: a first predicted resource that is based at least in part on a first measurement value, from the one or more measurement values, that is associated with the second resource and a first receive beam used to measure the first measurement value; and a second predicted resource that is based at least in part on a second measurement value, from the one or more measurement values, that is associated with the third resource and a second receive beam used to measure the second measurement value.

Aspect 30: The method of any of Aspects 21-29, wherein the CSI report comprises: an indication of a highest measurement value, from the one or more measurement values; one or more indications of remaining measurement values, from the one or more measurement values, as differential values with respect to the highest measurement value; and one or more indications of the one or more predicted measurement values as differential values with respect to respective measurement values from the one or more measurement values that are associated with the one or more predicted measurement values as indicated by the mapping.

Aspect 31: The method of Aspect 30, wherein the indication of the highest measurement value is associated with a first size, wherein each indication, from the one or more indications of remaining measurement values, is associated with a second size, and wherein each indication, from the one or more indications of the one or more predicted measurement values, is associated with a third size.

Aspect 32: The method of Aspect 31, further comprising: transmitting an indication of at least one of the first size, the second size, or the third size.

Aspect 33: The method of any of Aspects 30-32, wherein indications, from the one or more indications of the one or more predicted measurement values, associated with a measurement value, from the one or more measurement values includes: a first indication, associated with a first size, of a first predicted measurement value as a differential value with respect to the measurement value; and a second indication, associated with a second size, of a second predicted measurement value as a differential value with respect to the measurement value.

Aspect 34: The method of any of Aspects 30-33, wherein a first one or more indications, from the one or more indications of the one or more predicted measurement values, associated with a first measurement value, from the one or more measurement values, are associated with a first size; and wherein a second one or more indications, from the one or more indications of the one or more predicted measurement values, associated with a second measurement value, from the one or more measurement values, are associated with a second size.

Aspect 35: The method of any of Aspects 30-34, wherein a first one or more indications, from the one or more indications of the one or more predicted measurement values, associated with a first measurement value, from the one or more measurement values, include a first quantity of indications of predicted measurement values; and wherein a second one or more indications, from the one or more indications of the one or more predicted measurement values, associated with a second measurement value, from the one or more measurement values, include a second quantity of indications of predicted measurement values.

Aspect 36: The method of any of Aspects 21-35, wherein transmitting the indication that the UE is to transmit the CSI report comprises: transmitting a communication indicating one or more parameters associated with performing beam predictions associated with the CSI report.

Aspect 37: The method of Aspect 36, wherein the communication is a CSI report setting communication or a CSI resource setting communication.

Aspect 38: The method of any of Aspects 36-37, wherein the communication is at least one of a radio resource control communication, a medium access control (MAC) control element communication, or a downlink control information communication.

Aspect 39: The method of any of Aspects 36-38, wherein the communication includes: a radio resource control communication that indicates a first one or more parameters from the one or more parameters; and a medium access control (MAC) control element communication or a downlink control information communication that indicates a second one or more parameters from the one or more parameters.

Aspect 40: An apparatus for wireless communication at a device, comprising a processor; memory coupled with the processor; and instructions stored in the memory and executable by the processor to cause the apparatus to perform the method of one or more of Aspects 1-20.

Aspect 41: A device for wireless communication, comprising a memory and one or more processors coupled to the memory, the one or more processors configured to perform the method of one or more of Aspects 1-20.

Aspect 42: An apparatus for wireless communication, comprising at least one means for performing the method of one or more of Aspects 1-20.

Aspect 43: A non-transitory computer-readable medium storing code for wireless communication, the code comprising instructions executable by a processor to perform the method of one or more of Aspects 1-20.

Aspect 44: A non-transitory computer-readable medium storing a set of instructions for wireless communication, the set of instructions comprising one or more instructions that, when executed by one or more processors of a device, cause the device to perform the method of one or more of Aspects 1-20.

Aspect 45: An apparatus for wireless communication at a device, comprising a processor; memory coupled with the processor; and instructions stored in the memory and executable by the processor to cause the apparatus to perform the method of one or more of Aspects 21-39.

Aspect 46: A device for wireless communication, comprising a memory and one or more processors coupled to the memory, the one or more processors configured to perform the method of one or more of Aspects 21-39.

Aspect 47: An apparatus for wireless communication, comprising at least one means for performing the method of one or more of Aspects 21-39.

Aspect 48: A non-transitory computer-readable medium storing code for wireless communication, the code comprising instructions executable by a processor to perform the method of one or more of Aspects 21-39.

Aspect 49: A non-transitory computer-readable medium storing a set of instructions for wireless communication, the set of instructions comprising one or more instructions that, when executed by one or more processors of a device, cause the device to perform the method of one or more of Aspects 21-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive, from a network node, an indication to transmit a channel state information (CSI) report, wherein the CSI report is associated with a first set of resources and a second set of resources, and wherein a mapping indicates that each resource included in the second set of resources is associated with at least one resource included in the first set of resources;
measure one or more signals associated with resources included in the first set of resources to obtain a set of measurement values; and
transmit, to the network node, the CSI report indicating:
one or more measurement values from the set of measurement values,
a first one or more resources, from the first set of resources, that are associated with the one or more measurement values,
a second one or more resources, from the second set of resources, that are selected based on the first one or more resources and the mapping, and
one or more predicted measurement values associated with the second one or more resources.

2. The UE of claim 1, wherein the one or more processors are further configured to:
identify the one or more measurement values based on a highest one or more measurement values from the set of measurement values; and
predict, for each resource included in the first one or more resources and based at least in part on at least one measurement value from the one or more measurement values, predicted measurement values for each resource, included in the second one or more resources, that are associated with each resource included in the first one or more resources,
wherein the one or more predicted measurement values are a highest one or more predicted measurement values from the predicted measurement values.

3. The UE of claim 1, wherein the CSI report indicates a receive beam associated with the UE for each resource included in the second one or more resources.

4. The UE of claim 1, wherein the mapping indicates that resources included in the second set of resources are associated with a respective single resource from the first set of resources.

5. The UE of claim 1, wherein quasi co-location (QCL) relationships between resources included in the second set of resources and a respective single resource from the first set of resources defines a receive beam to be used to receive the resources included in the second set of resources.

6. The UE of claim 1, wherein a receive beam associated with a first resource included in the second set of resources is based at least in part on the receive beam being used by the UE to measure a second resource, included in the first set of resources, that is associated with the first resource as indicated by the mapping.

7. The UE of any of claim 1, wherein the mapping indicates that resources included in the second set of resources are associated with respective multiple resources from the first set of resources.

8. The UE of claim 1, wherein a first resource, from the second set of resources, is associated with a second resource and a third resource from the first set of resources, and wherein the one or more predicted measurement values are associated with:
a first predicted resource that is based at least in part on a first measurement value, from the one or more measurement values, that is associated with the second resource and a first receive beam used to measure the first measurement value; and
a second predicted resource that is based at least in part on a second measurement value, from the one or more measurement values, that is associated with the third resource and a second receive beam used to measure the second measurement value.

9. The UE of claim 1, wherein the CSI report comprises:
an indication of a highest measurement value, from the one or more measurement values;
one or more indications of remaining measurement values, from the one or more measurement values, as differential values with respect to the highest measurement value; and
one or more indications of the one or more predicted measurement values as differential values with respect to respective measurement values from the one or more measurement values that are associated with the one or more predicted measurement values as indicated by the mapping.

10. The UE of claim 9, wherein the indication of the highest measurement value is associated with a first size,
wherein each indication, from the one or more indications of remaining measurement values, is associated with a second size, and
wherein each indication, from the one or more indications of the one or more predicted measurement values, is associated with a third size.

11-13. (canceled)

14. A network node for wireless communication, comprising:
a memory; and
one or more processors, coupled to the memory, configured to:
transmit an indication that a user equipment (UE) is to transmit a channel state information (CSI) report, wherein the CSI report is associated with a first set of resources and a second set of resources, and wherein a mapping indicates that each resource included in the second set of resources is associated with at least one resource included in the first set of resources; and
receive the CSI report, associated with the UE, indicating:
one or more measurement values from a set of measurement values,
a first one or more resources, from the first set of resources, that are associated with the one or more measurement values,
a second one or more resources, from the second set of resources, that are selected based on the first one or more resources and the mapping, and
one or more predicted measurement values associated with the second one or more resources.

15. (canceled)

16. A method of wireless communication performed by an apparatus of a user equipment (UE), comprising:
receiving, from a network node, an indication to transmit a channel state information (CSI) report, wherein the CSI report is associated with a first set of resources and a second set of resources, and wherein a mapping indicates that each resource included in the second set of resources is associated with at least one resource included in the first set of resources;
measuring one or more signals associated with resources included in the first set of resources to obtain a set of measurement values; and
transmitting, to the network node, the CSI report indicating:
one or more measurement values from the set of measurement values,
a first one or more resources, from the first set of resources, that are associated with the one or more measurement values,
a second one or more resources, from the second set of resources, that are selected based on the first one or more resources and the mapping, and
one or more predicted measurement values associated with the second one or more resources.

17. The method of claim 16, further comprising:
identifying the one or more measurement values based on a highest one or more measurement values from the set of measurement values; and
predicting, for each resource included in the first one or more resources and based at least in part on at least one measurement value from the one or more measurement values, predicted measurement values for each resource, included in the second one or more resources, that are associated with each resource included in the first one or more resources,
wherein the one or more predicted measurement values are a highest one or more predicted measurement values from the predicted measurement values.

18. The method of claim 16, wherein the CSI report indicates a receive beam associated with the UE for each resource included in the second one or more resources.

19. The method of claim 16, wherein the mapping indicates that resources included in the second set of resources are associated with a respective single resource from the first set of resources.

20. The method of claim 16, wherein quasi co-location (QCL) relationships between resources included in the second set of resources and a respective single resource from the first set of resources defines a receive beam to be used to receive the resources included in the second set of resources.

21. The method of claim 16, wherein a receive beam associated with a first resource included in the second set of resources is based at least in part on the receive beam being used by the UE to measure a second resource, included in the first set of resources, that is associated with the first resource as indicated by the mapping.

22. The method of claim 21, wherein the first resource is a quasi co-location (QCL) source resource for a transmission configuration indicator (TCI) state associated with the receive beam.

23. The method of claim 16, wherein a first resource, from the second set of resources, is associated with a second resource and a third resource from the first set of resources, and wherein the one or more predicted measurement values are associated with:
a first predicted resource that is based at least in part on a first measurement value, from the one or more measurement values, that is associated with the second resource and a first receive beam used to measure the first measurement value; and
a second predicted resource that is based at least in part on a second measurement value, from the one or more measurement values, that is associated with the third resource and a second receive beam used to measure the second measurement value.

24. The method of claim 16, wherein the CSI report comprises:
an indication of a highest measurement value, from the one or more measurement values;
one or more indications of remaining measurement values, from the one or more measurement values, as differential values with respect to the highest measurement value; and
one or more indications of the one or more predicted measurement values as differential values with respect to respective measurement values from the one or more measurement values that are associated with the one or more predicted measurement values as indicated by the mapping.

25-30. (canceled)
